(19) United States
(12) Patent Application Publication
(10) Pub. No.: US 2020/0117183 A1
(43) Pub. Date: Apr. 16, 2020

(54) ELECTRONIC DEVICE FOR CONTROLLING UNMANNED AERIAL VEHICLE, AND UNMANNED AERIAL VEHICLE AND SYSTEM CONTROLLED THEREBY

(71) Applicant: Samsung Electronics Co., Ltd., Gyeonggi-do (KR)

(72) Inventors: Choon Kyoung MOON, Gyeonggi-do (KR); Eun Kyung YOO, Seoul (KR)

(21) Appl. No.: 16/497,711

(22) PCT Filed: Apr. 12, 2018
(86) PCT No.: PCT/KR2018/004288

§ 371 Date: Sep. 25, 2019

(30) Foreign Application Priority Data
Apr. 12, 2017 (KR) 10-2017-0047200

(51) Int. Cl. G05D 1/00; G08C 23/04; H04B 10/116; G05D 1/10; B64C 39/02; G01C 9/00; G01P 15/00; G01C 17/30

(52) U.S. Cl. CPC G05D 1/0016; G08C 23/04; H04B 10/116; G05D 1/101; B64C 39/024; B64C 2201/108; G01P 15/00; G01C 17/30; B64C 2201/027; B64C 2201/146; B64C 2201/042; G01C 9/005

(57) ABSTRACT

An electronic device is disclosed. The electronic device according to one embodiment comprises: a housing; a sensor for sensing a movement of the electronic device; a visible light communication (VLC) output module, disposed on one side of the housing, for outputting a VLC signal; and a processor disposed within the housing and electrically connected to the sensor and the VLC output module, wherein the processor may be configured to generate control information for controlling a movement of an unmanned aerial vehicle (UAV) on the basis of the detected movement of the electronic device, and to output the VLC signal including the control information to the UAV by using the VLC output module. Other various embodiments as understood from the specification are also possible.

### TECHNICAL FIELD

Embodiments disclosed in the disclosure relate to a technology for controlling an unmanned aerial vehicle (UAV).

### BACKGROUND ART

A UAV (e.g., drone) may be a device driven by the induction of radio waves without the boarding of a person. The UAV has been originally developed for military purposes, such as reconnaissance, surveillance, or the like. However, the application range of the UAV has been recently expanded to use shipments, photography, and video capture.

The UAV may fly in response to a wireless control signal generated by a separate manipulation device. The UAV may change the altitude depending on the control signal of the manipulation device or may move or rotate at the same altitude. When the UAV includes a camera device, the UAV may capture a photo or a video.

### DISCLOSURE

### Technical Problem

A UAV system provides an input device that includes a stick, a touch pad, or the like that is capable of controlling the operation of the UAV. The UAV may move in a specific direction depending on the control information received from the input device.

For the purpose of changing the altitude of the UAV or moving or rotating the UAV in three-dimensional space in a conventional method of manipulating the UAV, beginners need to manipulate the two joysticks in a complex form; it is difficult for beginners to manipulate the UAV because the posture, the direction, and the distance of the UAV are continuously changed depending on the manipulation.

Various embodiments of the disclosure, it is possible to control an electronic device through which beginners are capable of intuitively and easily controlling the UAV.

Furthermore, a conventional device controlling a UAV requires GPS information of the UAV to control the UAV at the third person viewpoint. Because it is difficult to obtain the GPS information indoors, it is difficult to control the UAV at the third person viewpoint.

Various embodiments of the disclosure may provide an electronic device capable of controlling a UAV at the third person viewpoint even in an environment where it is difficult to obtain GPS information.

### Technical Solution

According to an embodiment disclosed in this specification, an electronic device may include a housing, a sensor sensing a movement of the electronic device, a visible light communication (VLC) output module disposed on one side of the housing and outputting a VLC signal, and a processor disposed within the housing and electrically connected to the sensor and the VLC output module. The processor may be configured to generate control information for controlling a movement of an unmanned aerial vehicle (UAV) based on the sensed movement of the electronic device and to output the VLC signal including the control information to the UAV by using the VLC output module.

Furthermore, according to an embodiment disclosed in this specification, a UAV may include a housing, a plurality of optical sensors disposed on the housing and obtaining a VLC signal including control information from an electronic device, a decoder obtaining the control information from the VLC signal, at least one motor connected to the housing, at least one propeller connected to the at least one motor, a processor disposed within the housing and electrically connected to the plurality of optical sensors, the decoder, and the at least one motor. The processor may be configured to control the motor such that the UAV moves to a target point determined based on a first distance between the electronic device and the UAV, a second distance between the electronic device and the target point to which the UAV will move, a direction from the UAV to the electronic device, and the control information. The first distance may be determined based on a magnitude of the obtained VLC signal, and the control information may include an angle between a first direction from the electronic device to the UAV and a second direction from the electronic device to the target point.

Furthermore, according to an embodiment disclosed in this specification, a system may include an electronic device and a UAV. The electronic device may include a first housing, a sensor sensing a movement of the electronic device, a VLC output module disposed on one side of the first housing and outputting a VLC signal, and a first processor disposed within the first housing and electrically connected to the sensor and the VLC output module. The first processor may be configured to generate control information for controlling a movement of the UAV based on the sensed movement of the electronic device and to output the VLC signal including the control information to the UAV by using the VLC output module. The UAV may include a second housing, a plurality of optical sensors disposed on the second housing and obtaining a VLC signal including control information, a decoder obtaining the control information from the VLC signal, at least one motor connected to the second housing, at least one propeller connected to the at least one motor, a second processor disposed within the second housing and electrically connected to the plurality of optical sensors, the decoder, and the at least one motor. The second processor may be configured to control the motor such that the UAV moves to a target point determined based on a first distance between the electronic device and the UAV, a second distance between the electronic device and the target point to which the UAV will move, a direction from the UAV to the electronic device, and the control information. The first distance may be determined based on a magnitude of the received VLC signal, and the control information may include an angle between a first direction from the electronic device to the UAV and a second direction from the electronic device to the target point.

### Advantageous Effects

According to embodiments disclosed in the disclosure, it is possible to intuitively control a UAV without considering the posture of the UAV.

According to various embodiments of the disclosure, interference between various wireless communication signals may be reduced because VLC communication is used.

According to various embodiments of the disclosure, it is possible for a user to easily manipulate the UAV with one hand.

Besides, a variety of effects directly or indirectly understood through the disclosure may be provided.

### DESCRIPTION OF DRAWINGS

FIG. 1 is a block diagram of an electronic apparatus according to an embodiment.

FIG. 2 illustrates a block diagram of a UAV, according to an embodiment.

FIG. 3A is a view illustrating a front surface and a rear surface of an electronic device, according to an embodiment.

FIG. 3B illustrates a front surface and a side surface of an electronic device according to an embodiment.

FIG. 4 illustrates an appearance of a UAV, according to an embodiment.

FIG. 5 illustrates a structure of a UAV command packet, according to an embodiment.

FIG. 6 is a flowchart illustrating a pairing procedure between an electronic device and a UAV, according to an embodiment.

FIG. 7A is a flowchart illustrating a procedure in which an electronic device controls a UAV, according to an embodiment.

FIG. 7B illustrates a distance between an electronic device and a UAV, a distance between an electronic device and a target point, and a direction facing an electronic device from a UAV, according to an embodiment.

FIG. 8 illustrates a spherical coordinate system illustrating a rotational direction of an electronic device, according to an embodiment.

FIG. 9 is a graph illustrating a VLC signal output by an electronic device, according to an embodiment.

FIG. 10A is a graph illustrating a VLC signal obtained by an optical sensor of the UAV 200, according to an embodiment.

FIG. 10B is a graph illustrating a VLC signal obtained by an optical sensor of the UAV 200, according to another embodiment.

FIG. 11A is a view illustrating that a UAV moves depending on an azimuth change of an electronic device, according to an embodiment.

FIG. 11B is a view illustrating that a UAV moves depending on a change of an inclination angle of an electronic device, according to an embodiment.

FIG. 11C is a view illustrating that a UAV moves depending on a user input to generate distance change information, according to an embodiment.

FIG. 11D is a view illustrating that a UAV changes a posture depending on a user input to generate posture change information, according to an embodiment.

FIG. 12A is a view illustrating that a UAV takes off by a user input, according to an embodiment.

FIG. 12B is a view illustrating that a UAV rotates by a user input such that one side of a UAV faces an electronic device, according to an embodiment.

FIG. 12C is a view illustrating an image in which a viewfinder is displayed is switched by a user input, according to an embodiment.

FIG. 12D is a view illustrating that a capture mode of an electronic device is executed by a user input, according to an embodiment.

FIG. 13 is a block diagram of an electronic apparatus according to an embodiment.

FIG. 14 illustrates a block diagram of a UAV, according to an embodiment.

FIG. 15 is a flowchart illustrating a procedure in which an electronic device controls a UAV, according to an embodiment.

FIG. 16A is a view illustrating that a UAV moves depending on rotation of an electronic device, according to an embodiment.

FIG. 16B is a view illustrating that a UAV moves depending on a distance change input, according to an embodiment.

FIG. 17A is a view illustrating that an altitude of a UAV is changed depending on the inclination of an electronic device, according to an embodiment.

FIG. 17B is a view illustrating that an altitude of a UAV is changed depending on an inclination of an electronic device, according to another embodiment.

FIG. 18 illustrates a screen in which a UI for controlling movement of a camera of a UAV is displayed, according to an embodiment.

FIG. 19 illustrates a block diagram of an electronic device in a network environment according to various embodiments.

FIG. 20 is a block diagram of a UAV, according to an embodiment.

FIG. 21 is a diagram illustrating a platform of a UAV, according to an embodiment.

With regard to description of drawings, similar components may be marked by similar reference numerals.

### MODE FOR INVENTION

Hereinafter, various embodiments of the disclosure may be described with reference to accompanying drawings. Accordingly, those of ordinary skill in the art will recognize that modification, equivalent, and/or alternative on the various embodiments described herein can be variously made without departing from the scope and spirit of the disclosure.

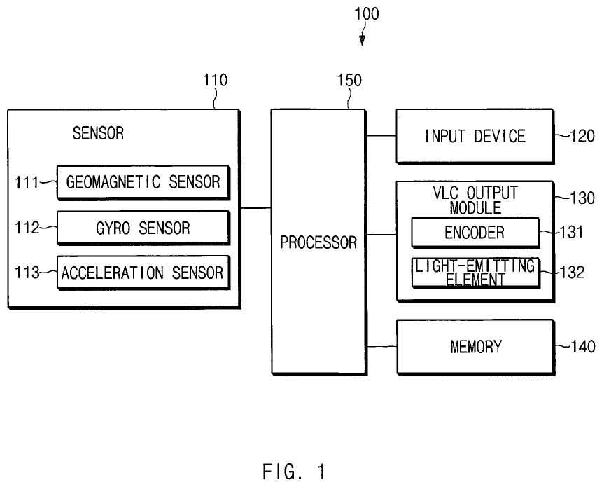

FIG. 1 is a block diagram of an electronic apparatus according to an embodiment.

According to an embodiment, an electronic device 100 may include housing and may include a sensor 110, an input device 120, a visible light communication (VLC) output module 130, a memory 140, and a processor 150. In various embodiments, the electronic device 100 may omit a part of the above-mentioned components or may further include other components. For example, a component such as a display, a camera, a battery, an input/output interface, or a communication circuit may be further included in the electronic device 100.

The sensor 110 may sense the posture and the movement of the electronic device 100 and may include at least one of a geomagnetic sensor 111, a gyro sensor 112, or an acceleration sensor 113. The geomagnetic sensor 111 may sense the azimuth of the electronic device 100. The gyro sensor 112 may sense the inclination of the electronic device 100. In an embodiment, the gyro sensor 112 may sense an inclination angle indicating the inclination of the electronic device 100. The acceleration sensor 113 may sense the acceleration of the electronic device 100. The sensor 110 may provide information about the sensed posture and movement of the electronic device 100, to the processor 150.

The input device 120 may generate an input signal according to a user input of the electronic device 100. For example, the input device 120 may include at least one of a stick-type device, a button-type device, or a touch pad-type device. The input device 120 may be provided in the form of a touch screen panel. According to an embodiment, the input device 120 may transmit a user input signal associated with the movement start of the unmanned aerial vehicle (UAV) 200, the posture change of the UAV 200, the change in the distance between the electronic device 100 and the target point to which the UAV 200 will move, or the like, to the processor 150 in response to a user input. According to various embodiments, the electronic device 100 may include a microphone, a speaker, or the like. The microphone may be included in the input device 120. The input device 120 including the microphone may obtain a user voice input and may perform input processing based on voice recognition for the obtained voice input.

The VLC output module 130 may include an encoder 131 and a light-emitting element 132. The encoder 131 may generate a VLC signal from the control information generated by a processor 250. The light-emitting element 132 may output the VLC signal generated by the encoder 131. The light-emitting element 132 is disposed on one side of the housing of the electronic device and may output the generated VLC signal. For example, the light-emitting element 132 may include a light-emitting diode (LED), or the like.

The memory 140 may store at least one application or data associated with the operation of the electronic device 100. According to an embodiment, the memory 140 may store an operation application program associated with the operation of the UAV 200. According to various embodiments, the application program may include an instruction set for transmitting, to the UAV 200, posture change information of the UAV 200 and control information for moving the UAV 200 in response to the movement of the electronic device 100.

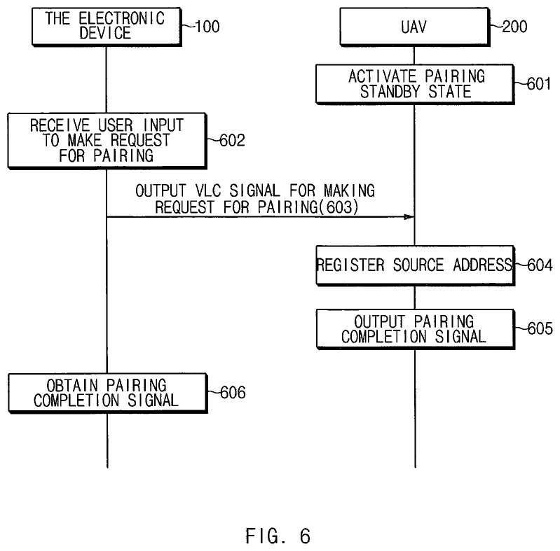

The processor 150 may process or transmit a signal associated with the control of the electronic device 100. According to an embodiment, the processor 150 may be disposed in the housing and may be electrically connected to the sensor 110, the VLC output module 130, and the memory 140. According to an embodiment, the processor 150 may generate control information for controlling the movement of the UAV 200, based on the detected movement of the electronic device 100 and may output a VLC signal including the control information to the UAV 200, using the VLC output module 130. The described operation of the processor 150 will be described below with reference to FIGS. 6 to 12D.

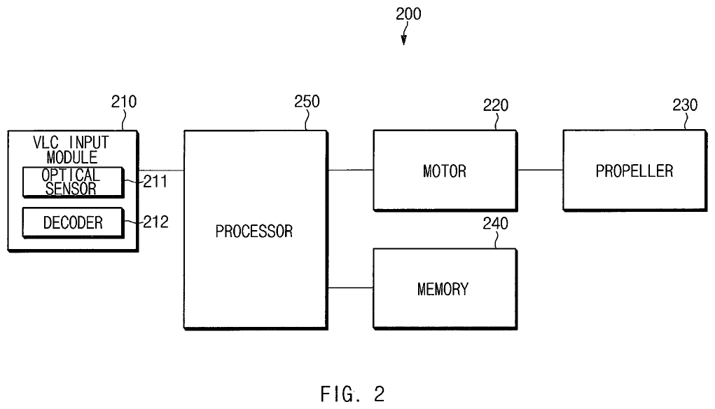

FIG. 2 illustrates a block diagram of a UAV, according to an embodiment.

According to an embodiment, the UAV 200 may include housing and may include a VLC input module 210, a motor 220, a propeller 230, a memory 240, and a processor 250. In various embodiments, the electronic device may omit a part of the above-mentioned components or may further include other components. For example, the component such as an IR sensor (an infrared ray sensor), an ultrasound sensor, an optical flow switch (OFS), a camera, or a battery may be additionally included in the UAV 200.

The VLC input module 210 may include an optical sensor 211 and a decoder 212. The optical sensor 211 may be disposed on the housing of the UAV 200, and a plurality of optical sensors 211 may be provided. The optical sensor 211 may receive the VLC signal output by the VLC output module 130 of the electronic device. The decoder 212 may obtain control information for controlling the movement of the UAV 200, from the VLC signal received by the optical sensor 211.

Each of the motor 220 and the propeller 230 is a driving means for moving the UAV 200. One or more motors 220 and one or more propellers 230 may be provided. The motor 220 may be connected to the housing and may be controlled by the processor 250. The propeller 230 may be connected to the motor 220; as the motor 220 operates, the propeller 230 may rotate to generate lift force, and thus may move the UAV 200.

The memory 240 may store at least one program, at least one application, at least a piece of data, or the like associated with the operation of the UAV 200. According to an embodiment, the memory 240 may store a flight application associated with operation control for moving or rotating the UAV 200, based on the control information included in the obtained VLC signal. For example, the flight application may include an instruction set for extracting posture change information in the collected control information provided by the electronic device or control information for moving the UAV 200 in response to the posture or the movement of the electronic device, an instruction set for moving the UAV 200 depending on the extracted control information, or the like.

The processor 250 may process a signal associated with the control of the UAV 200. According to an embodiment, the processor 250 may be disposed in the housing and may be electrically connected to the VLC input module 210 and the motor 220. According to an embodiment, the processor 250 may control the motor 220 such that the UAV 200 moves to the target point determined based on the distance between the electronic device and the UAV 200, the direction facing the electronic device from the UAV 200, and the control information. The described operation of the processor 250 will be described below with reference to FIGS. 6 to 12D.

According to various embodiments, the above-described the electronic device 100 and the UAV 200 may operate as the configuration of a system including the electronic device 100 and the UAV 200.

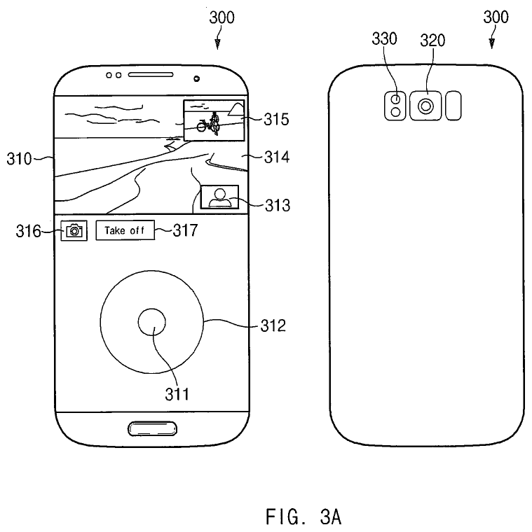

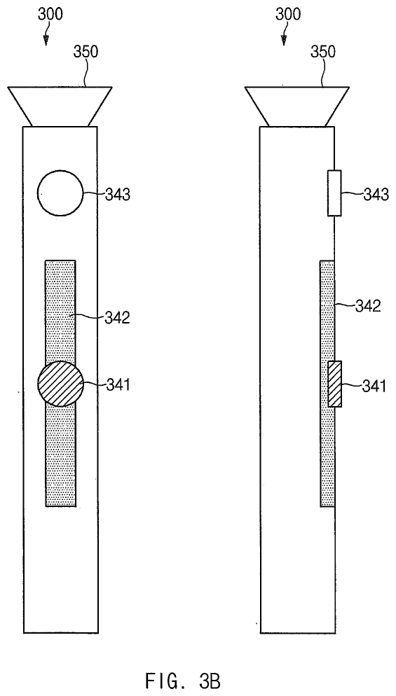

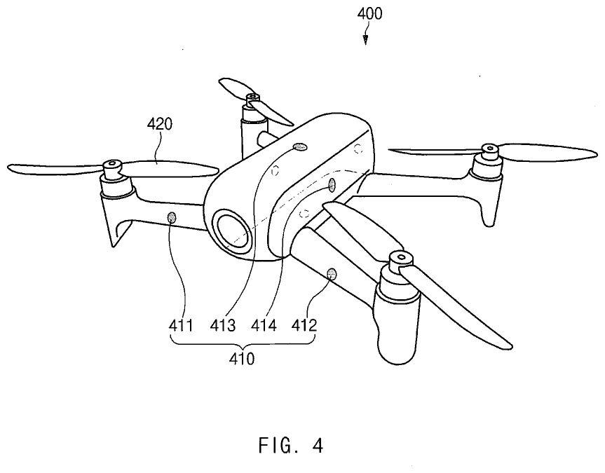

Hereinafter, the appearance of an electronic device and a UAV according to various embodiments will be described with reference to FIGS. 3A to 4.

FIG. 3A is a view illustrating a front surface and a rear surface of an electronic device, according to an embodiment.

Referring to FIG. 3A, an electronic device 300 may include a display 310 on the front surface and may include a camera 320 and a light-emitting element 330 on the rear surface.

The display 310 may output the execution screen of an application. In an embodiment, the display 310 may be implemented with a touch panel (e.g., a touch screen panel, or the like). In this case, a user may generate a user input by touching the display 310. In other words, in the case where the display 310 is integrally implemented with a touch panel, it is understood that the display 310 performs the functions of an input device and an output device together.

The display 310 may display user interfaces (UIs) 311, 312, 313, 316, and 317, a viewfinder 314 in which the image obtained by the camera 320 of the electronic device 300 is displayed, and a viewfinder 315 in which the image obtained by the camera of the UAV 200 is displayed. In an embodiment, the UIs 311, 312, 313, 314, 316, and 317 displayed by the display 310 may include the movement control UI 311, posture change UIs 312 and 313, a camera control UI 316, and a takeoff/landing control UI 317 of the UAV 200. The function of each UI will be described below.

The camera 320 may be disposed on the rear surface of the electronic device 300 and may obtain an image.

The light-emitting element 330 may be disposed on the rear surface of the electronic device 300 and may be an LED outputting a VLC signal under the control of the processor 150.

FIG. 3B illustrates a front surface and a side surface of the electronic device 300 according to an embodiment.

Referring to FIG. 3B, the electronic device 300 may include input devices 341, 342, and 343 and a light-emitting element 350.

The input device may include the movement control button 341, the location recognition sensor 342 of the movement control button, and the mode switch button 343.

The movement control button 341 may obtain a user input to trigger control information generation of the processor 150 of the electronic device 300. For example, when a user input to press the movement control button 341 occurs, the processor 150 of the electronic device 300 may generate control information based on the variations of the azimuth and inclination angle of the electronic device 300 detected from a point in time when the user input occurs.

The location recognition sensor 342 of the movement control button may move along a length direction of the location recognition sensor 342 of the movement control button.

The location recognition sensor 342 of the movement control button may recognize the location of the movement control button 341. The processor 150 of the electronic device 300 may generate control information based on the recognized location of the movement control button 341.

The mode switch button 343 may obtain a user input to switch a type of control information generated by the processor 150 of the electronic device 300. For example, in the case where a user input to press the mode switch button 343 occurs when a control information generating mode of the processor 150 of the electronic device 300 is a distance change mode between the electronic device 300 and the UAV 200, the control information generating mode may be switched to a camera movement control mode or a posture change mode.

The light-emitting element 350 may be an LED outputting a VLC signal under the control of the processor.

FIG. 4 illustrates an appearance of a UAV, according to an embodiment.

Referring to FIG. 4, a UAV 400 may include a plurality of optical sensors 410 and a plurality of propellers 420.

The plurality of optical sensors 410 may be disposed on the housing of the UAV 400 and may obtain a VLC signal. In an embodiment, the plurality of optical sensors 410 may obtain the VLC signal, of which the light source in all directions of the UAV 400 is output. The location of each of the plurality of optical sensors 410 and the magnitude of the VLC signal obtained by each of the plurality of optical sensors 410 may be used to determine the direction facing a light source (e.g., an electronic device) from the UAV 400. The detailed method of determining the direction facing a light source from the UAV 400 will be described below.

The plurality of propellers 420 may be connected to a plurality of motors embedded in the housing, respectively; as a motor is operated, the plurality of propellers 420 may rotate to generate lift force and then may move the UAV 400.

Before the operation between the electronic device and the UAV is described, the structure of a UAV command packet will be described.

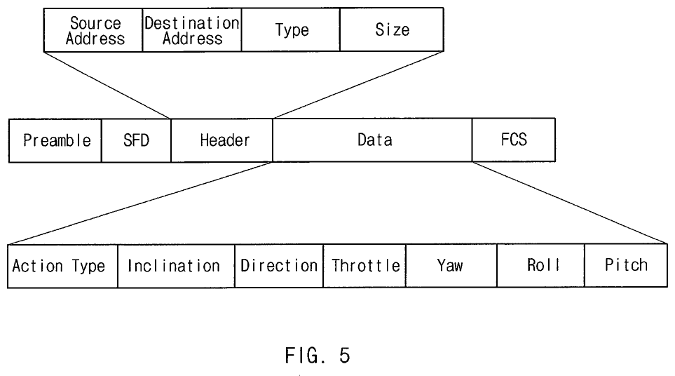

FIG. 5 illustrates a structure of a UAV command packet, according to an embodiment. Referring to FIG. 5, the UAV command packet may include a preamble, a start of frame delimiter (SFD), a header, data, a frame check sequence (FCS), and the like.

The preamble is the portion for synchronizing a packet located at the beginning of each packet. The SFD is the portion for providing a notification that data is composed in units of bytes from the SFD bit string.

The header may include a source address, a destination address, a type, a size, and the like. The source address may include the address of a packet sender, and the destination address may include the address of a packet recipient. The type may include the type of action to be performed using a packet, and the size may include the size of a packet.

The data may include control information for controlling the UAV. For example, the data may include an action type, an inclination, a direction, a throttle, a yaw, a roll, a pitch, and the like. In an embodiment, the action type may include follow, move, or the like. The inclination may include inclination information of the UAV, and the direction may include the geomagnetic field direction of the UAV. The throttle may include information associated with the vertical movement of the UAV, and the yaw may include information associated with the posture of the UAV. The roll may include information associated with the lateral movement of the UAV, and the pitch may include information associated with the frontward/backward movement of the UAV.

The FCS is a portion for determining whether there is a problem with the packet.

According to an embodiment, before the electronic device 100 controls the UAV 200, the electronic device 100 and the UAV 200 may be paired with each other.

FIG. 6 is a flowchart illustrating a pairing procedure between an electronic device and a UAV, according to an embodiment.

The electronic device 100 and the UAV 200 of FIG. 6 may include all or part of components of the electronic device 100 and the UAV 200 described with reference to FIGS. 1 and 2.

Referring to FIG. 6, in operation 601, the UAV 200 may activate a pairing standby state. According to an embodiment, when the power of the UAV 200 is turned on or the UAV 200 obtains a specified input (e.g., a specified button input), the UAV 200 may activate the pairing standby state.

In operation 602, the electronic device 100 may receive a user input to make a request for pairing with the UAV 200. According to an embodiment, the electronic device 100 may execute an application and may receive the user input, using the executed application.

In operation 603, the electronic device 100 may output a VLC signal for making a request for the pairing with the UAV 200, to the UAV 200 in response to the user input.

The VLC signal for making a request for the pairing may include a UAV command packet. In an embodiment, the type of the UAV command packet included in the VLC signal may be a pairing request, and the UAV command packet may include the source address of the electronic device 100.

In operation 604, the UAV 200 may register a source address corresponding to the electronic device 100, in the memory of the UAV 200.

In operation 605, the UAV 200 may output a pairing completion signal.

In an embodiment, the UAV 200 may further include a light-emitting element or a speaker. For the purpose of providing a notification of the completion of the pairing, the UAV 200 may output a pairing completion optical signal (e.g., blinking depending on a preset pattern) using a light-emitting element or may output a pairing completion sound signal (e.g., a preset sound) using a speaker.

In operation 606, the electronic device 100 may obtain a pairing completion signal.

In an embodiment, the electronic device 100 may further include an optical sensor, a communication device, or a microphone. The electronic device 100 may obtain an optical signal output by the light-emitting element of the UAV 200 by using the optical sensor, a communication signal, or a sound signal output by the speaker of the UAV 200. After the electronic device 100 obtains the pairing completion signal, the electronic device 100 may determine that the pairing with the UAV 200 is completed.

When the pairing is completed, the UAV 200 may be set to be controlled by only the control information included in the VLC signal output by the paired electronic device 100.

Hereinafter, a method in which an electronic device controls a UAV will be described with reference to FIGS. 3A to 4 and 7A to 12D.

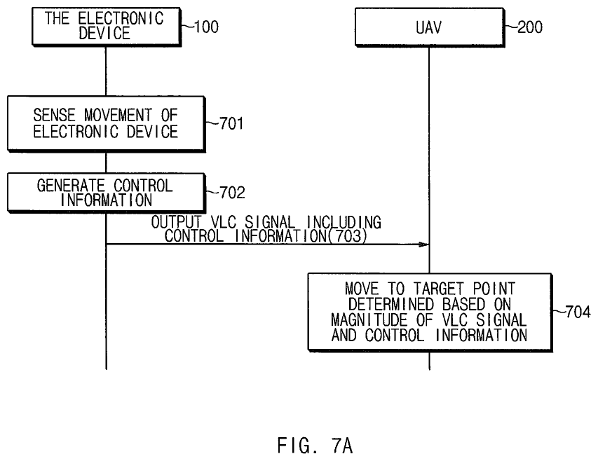

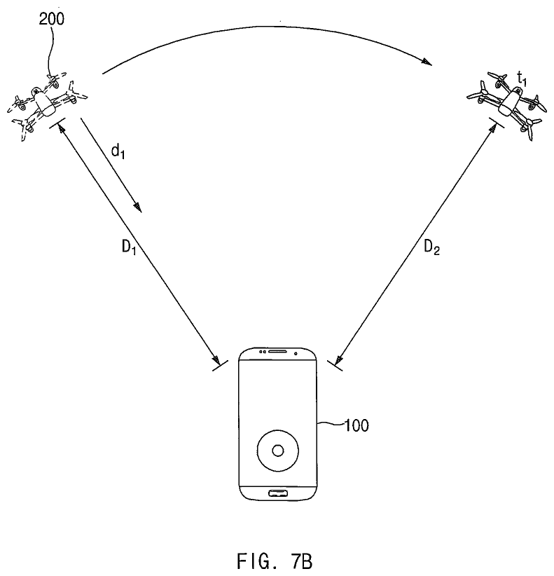

FIG. 7A is a flowchart illustrating a procedure in which an electronic device controls a UAV, according to an embodiment.

The electronic device 100 and the UAV 200 of FIG. 7A may include all or part of components of the electronic device 100 and the UAV 200 described with reference to FIGS. 1 and 2.

Referring to FIG. 7A, in operation 701, the sensor 110 of the electronic device 100 may sense the movement of the electronic device 100.

In an embodiment, the movement of the electronic device 100 may include the change of the posture of the electronic device 100. The posture of the electronic device 100 may mean the direction facing one side of housing. The geomagnetic sensor 111 may sense the azimuth in the direction facing one side of the housing. The gyro sensor 112 may sense the inclination angle in the direction facing one side of the housing, and the inclination angle may indicate the degree of inclination of the housing.

In an embodiment, the change of the posture of the electronic device 100 may mean the rotation of the electronic device 100, and the rotation of the electronic device 100 may be expressed as the variation of the azimuth and the inclination angle of the direction in which one side of the housing faces.

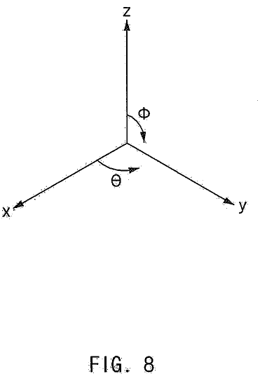

FIG. 8 illustrates a spherical coordinate system illustrating a rotational direction of the electronic device 100, according to an embodiment.

In an embodiment, the gyro sensor 112 may sense the rotation of the electronic device 100, the rotation axis of which is vertical, and the rotation of the electronic device 100, the rotation axis of which is horizontal. The rotation information of the electronic device 100, which is sensed by the gyro sensor 112 and of which the rotation axis is vertical may be expressed as a theta θ value of the spherical coordinate system illustrated in FIG. 8. The rotation information of the electronic device 100, which is sensed by the gyro sensor 112 and of which the rotation axis is horizontal may be expressed as a pie Φ value of the spherical coordinate system illustrated in FIG. 8.

According to an embodiment, the processor 150 of the electronic device 100 may calculate the rotation angle, the rotational angular velocity, the movement speed, the movement distance, or the like of the electronic device 100, based on the sensed movement of the electronic device 100.

The movement of the electronic device 100 may include the location movement of the electronic device 100. The acceleration sensor 113 may sense the acceleration of the location movement of the electronic device 100.

In operation 702, the processor 150 of the electronic device 100 may generate control information for controlling the movement of the UAV 200, based on the movement of the electronic device 100.

In an embodiment, the processor 150 of the electronic device 100 may generate the control information based on the movement of the electronic device 100 detected from a point in time when a user input is obtained. For example, the processor 150 of the electronic device 100 may generate the control information using the movement of the electronic device 100 detected after the user input is obtained, without using the movement of the electronic device 100 detected before the user input is obtained. In other words, the user input may trigger the generation of the control information.

According to an embodiment, a user input to trigger the generation of the control information may be a user input to select the movement control UI 311 illustrated in FIG. 3A.

According to another embodiment, the user input to trigger the generation of the control information may be a user input to press the movement control button 341 of a UAV illustrated in FIG. 3B.

In an embodiment, the control information may include the angle between the first direction facing the UAV 200 from the electronic device 100 and the second direction facing the target point, to which the UAV 200 will move, from the electronic device 100. The processor of the electronic device 100 may determine the angle between the first direction and the second direction based on the changes of the azimuth and the inclination angle of the electronic device 100. According to an embodiment, the angle between the first direction and the second direction may be proportional to the variation of each of the azimuth and inclination angle of the electronic device 100. For example, when the variation of the azimuth of the electronic device 100 is 10 degrees and when the variation of the inclination angle is 20 degrees, the angle between the first direction and the second direction may be 10 degrees in the horizontal direction and 20 degrees in the vertical direction.

In an embodiment, the control information may include at least one of the rotational angular velocity of the electronic device 100 or the movement speed of the UAV 200. According to an embodiment, the movement speed of the UAV 200 may be generated based on the rotational angular velocity of the electronic device 100. For example, the movement speed of the UAV 200 may be proportional to the rotational angular velocity of the electronic device 100.

In an embodiment, the distance between the electronic device 100 and the target point may be set to the distance between the electronic device 100 and the UAV 200, and the control information may include distance change information between the electronic device 100 and the target point. For example, the distance change information between the electronic device 100 and the target point may include the increment or decrement of the distance, and the distance may be the distance obtained by adding the increment to the distance between the electronic device 100 and the UAV 200 or the distance obtained by subtracting the decrement from the first distance. In an embodiment, the distance change information may include the absolute distance between the electronic device 100 and the target point.

In an embodiment, before operation 702, the input device 120 of the electronic device 100 may obtain a user input to generate the distance change information between the electronic device 100 and the target point.

For example, the user input to generate the distance change information may be a user input to drag the movement control UI 311 of FIG. 3A. According to an embodiment, when the processor 150 of the electronic device 100 obtains a user input to upwardly drag the movement control UI 311, the processor 150 of the electronic device 100 may generate the distance change information for increasing the distance between the electronic device 100 and the target point. According to an embodiment, when the processor 150 of the electronic device 100 obtains a user input to downwardly drag the movement control UI 311, the processor 150 of the electronic device 100 may generate the distance change information for decreasing the distance between the electronic device 100 and the target point.

According to an embodiment, the distance change information may include the displacement of the distance between the electronic device 100 and the target point, the distance change speed between the electronic device 100 and the target point, or the distance change acceleration between the electronic device 100 and the target point.

According to an embodiment, the displacement, the distance change speed, and the distance change acceleration may be proportional to the extent to which the movement control UI 311 is dragged.

In an embodiment, the control information may include the posture change information for changing the posture of the UAV 200. The posture of the UAV 200 may mean the direction in which one side of the housing of the UAV 200 faces.

In an embodiment, before operation 702, the input device 120 of the electronic device 100 may obtain a user input to generate the posture change information of the UAV 200.

For example, the user input to generate the posture change information of the UAV 200 may be a user input to drag the posture change UI 312 along the circle of the posture change UI 312 of the UAV of FIG. 3A. According to an embodiment, when the processor 150 of the electronic device 100 obtains a user input to drag the posture change UI 312 of the UAV clockwise, the processor 150 of the electronic device 100 may generate the posture change information that allows the UAV 200 to rotate clockwise.

In operation 703, the processor 150 of the electronic device 100 may output the VLC signal including control information to the UAV, using the VLC output module 130. The optical sensor 211 of the UAV 200 may obtain the VLC signal from the electronic device.

In operation 704, the processor 250 of the UAV 200 may control the motor 220 such that the UAV 200 moves to the target point determined based on the magnitude of the VLC signal and the control information.

In an embodiment, the processor 250 of the UAV 200 may determine the distance between the electronic device 100 and the UAV 200, as the first distance based on the obtained magnitude of the VLC signal. In particular, the processor 250 of the UAV 200 may determine the first distance based on the difference value between the magnitude of a first VLC signal corresponding to the logic high of the obtained VLC signal and the magnitude of a second VLC signal corresponding to the logic low. Because the VLC signal is an optical signal and the intensity of light is inversely proportional to the square of distance, the first distance may be inversely proportional to the square root of the difference value.

In an embodiment, the processor 250 of the UAV 200 may determine the second distance, which is the distance between the electronic device 100 and the target point to which the UAV 200 will move, based on the control information. According to an embodiment, the control information may include a second distance value. According to an embodiment, the control information may include the distance change information. The processor 250 of the UAV 200 may determine the distance, which is obtained by applying the distance change information to the first distance, as the second distance.

In an embodiment, the processor 250 of the UAV 200 may determine the direction facing the electronic device 100 from the UAV 200 based on locations of the plurality of optical sensors 211 and the magnitude of the VLC signal obtained by each of the plurality of optical sensors 211. The detailed method in which the processor 250 of the UAV 200 determines the direction facing the electronic device 100 from the UAV 200 will be described below.

FIG. 7B illustrates a distance between an electronic device and a UAV, a distance between an electronic device and a target point, and a direction facing an electronic device from a UAV, according to an embodiment.

According to an embodiment, referring to FIG. 7B, the processor 250 of the UAV 200 may determine a first distance D1, a second distance D2, and the direction facing the electronic device 100 from the UAV 200 and may control the motor 220 based on the control information included in the received VLC signal such that the UAV 200 moves to a target point t1.

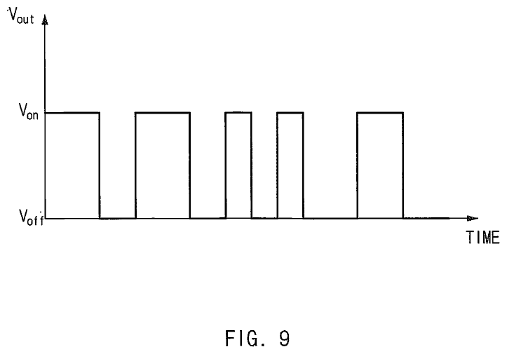

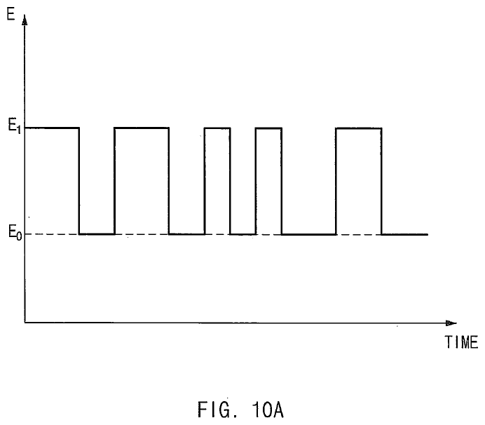

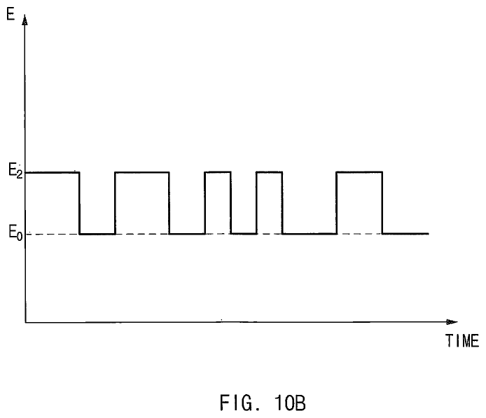

Hereinafter, a method in which the processor 250 of the UAV 200 determines the first distance will be described with reference to FIGS. 9 to 10B.

FIG. 9 is a graph illustrating a VLC signal output by an electronic device, according to an embodiment. FIG. 10A is a graph illustrating a VLC signal obtained by the optical sensor 211 of the UAV 200, according to an embodiment. FIG. 10B is a graph illustrating a VLC signal obtained by the optical sensor 211 of the UAV 200, according to another embodiment.

Referring to FIG. 9, the magnitude Voff of the VLC signal corresponding to logic low of the VLC signal output by the VLC output module 130 of an electronic device may be ‘0’.

Referring to FIGS. 10A and 10B, the intensity E0 of a VLC signal corresponding to logic low of the VLC signal obtained by the optical sensor 211 of the UAV 200 is not ‘0’. Generally, the UAV 200 is controlled at a location where ambient lighting (e.g., indoor lighting, solar lighting, or the like) is present. Accordingly, the intensity E0 of a VLC signal corresponding to logic low of the VLC signal obtained by the optical sensor 211 of the UAV 200 may be the intensity of light of ambient lighting. Because the intensity of the VLC signal corresponding to logic high of the VLC signal obtained by the optical sensor 211 of the UAV 200 is E1 or E2 greater than E0, the processor 250 of the UAV 200 may interpret the VLC signal.

Because the intensity of the VLC signal obtained by the optical sensor 211 of the UAV 200 includes the intensity of ambient lighting, the processor 250 of the UAV 200 may determine the first distance, using the difference value between the magnitude of the first VLC signal corresponding to logic high of the VLC signal and the magnitude of the second VLC signal corresponding to logic low.

As illustrated in FIG. 10A, when the optical sensor 211 of the UAV 200 obtains the VLC signal, the processor 250 of the UAV 200 may determine the first distance, using ‘E1-E0’ value. As illustrated in FIG. 10B, when the optical sensor 211 of the UAV 200 obtains the VLC signal, the processor 250 of the UAV 200 may determine the first distance, using ‘E2-E0’ value.

Referring to FIGS. 10A and 10B, because ‘E2−E0’ value is less than ‘E1−E0’ value, the first distance determined by the processor 250 of the UAV 200 in the embodiment of FIG. 10A is shorter than the first distance determined in the embodiment of FIG. 10B.

According to an embodiment, the processor 250 of the UAV 200 may determine the first distance, using data obtained by machine learning. The data obtained by machine learning may include data including the first distance corresponding to the difference value between the magnitude of the first VLC signal corresponding to logic high of the VLC signal and the magnitude of the first VLC signal corresponding to logic low.

In an embodiment, the second distance may be the same as the first distance. In an embodiment, when the second distance is the same as the first distance, the processor 250 of the UAV 200 may move while maintaining the distance to the electronic device 100. In other words, the UAV 200 may move along a spherical surface, of which the center is the electronic device 100 and of which the radius is the first distance.

In an embodiment, the second distance may be a distance to which the distance change information is applied.

In an embodiment, the direction facing the electronic device 100 from the UAV 200 may be determined based on locations of the plurality of optical sensors 211 and the magnitude of the VLC signal obtained by each of the plurality of optical sensors 211.

A method in which the processor 250 of the UAV 200 determines a direction facing an electronic device from a UAV will be described with reference to FIG. 4.

In an embodiment, the optical sensors 411 and 412 disposed on the front surface of the housing of the UAV 400 may obtain the VLC signal of which the light source in the front direction of the UAV 400 is output. The optical sensor 413 disposed on the upper surface of the housing may obtain the VLC signal of which the light source in the upper direction of the UAV 400 is output. The optical sensor 414 disposed on the left surface of the housing may obtain the VLC signal generated as the light source in the left direction of the UAV 400 is output. The processor 250 of the UAV 200 may determine the direction facing the light source from the UAV 400, based on the location of the optical sensor 410 obtaining the VLC signal.

In an embodiment, when the VLC signal is output by the light source in the upper left direction of the UAV 400, both the optical sensor 413 disposed on the upper surface of the housing and the optical sensor 414 disposed on the left surface of the housing may obtain the VLC signal. The processor 250 of the UAV 200 may determine the direction facing the light source from the UAV 400 based on locations of the optical sensors 413 and 414 and the magnitude of the VLC signal obtained by each of the optical sensors 413 and 414.

For example, the processor 250 of the UAV 200 may determine the direction facing the light source from the UAV, using the first difference value between the magnitude of the first VLC signal corresponding to logic high of the VLC signal and the magnitude of the second VLC signal corresponding to logic low, which are obtained by the optical sensor 413 disposed on the upper surface of the housing, and the second difference value between the magnitude of the third VLC signal corresponding to logic high of the VLC signal and the magnitude of the fourth VLC signal corresponding to logic low, which are obtained by the optical sensor 414 disposed on the left surface of the housing.

According to an embodiment, the processor 250 of the UAV 200 may determine the first distance, using data obtained by machine learning. The data obtained by machine learning may include data including the direction facing a light source from the UAV 200 corresponding to the ratio of the difference value between the magnitude of the VLC signal of logic high of each of the plurality of optical sensors 211 and the magnitude of the VLC signal of logic low of each of the plurality of optical sensors 211.

In an embodiment, the control information may include at least one of the rotational angular velocity of the electronic device 100 or the movement speed of the UAV 200. According to an embodiment, the processor 250 of the UAV 200 may move at a speed proportional to the rotational angular velocity. According to an embodiment, the UAV 200 may move at the movement speed of the UAV 200 included in the control information.

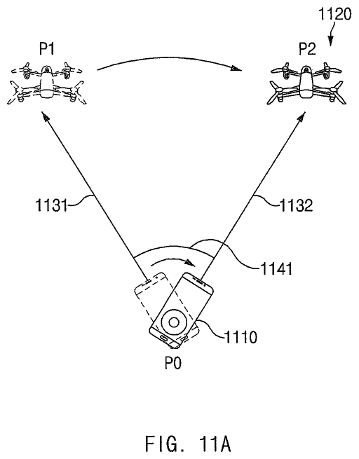

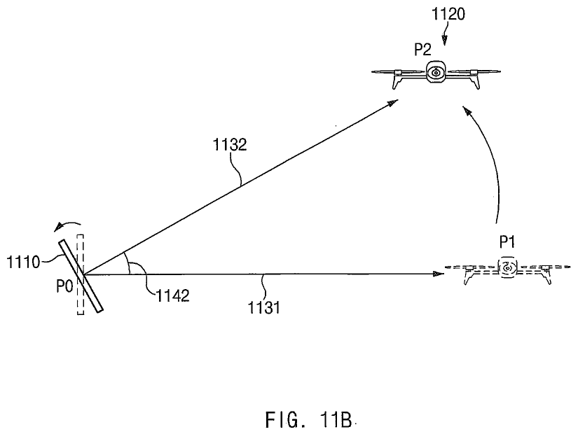

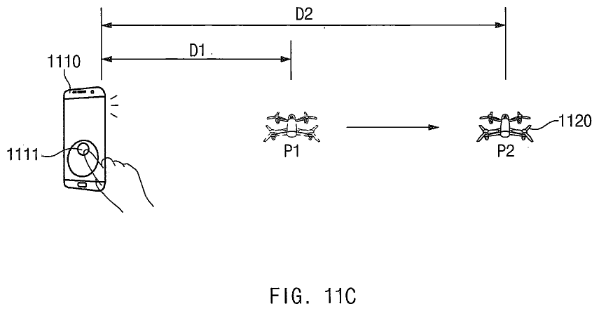

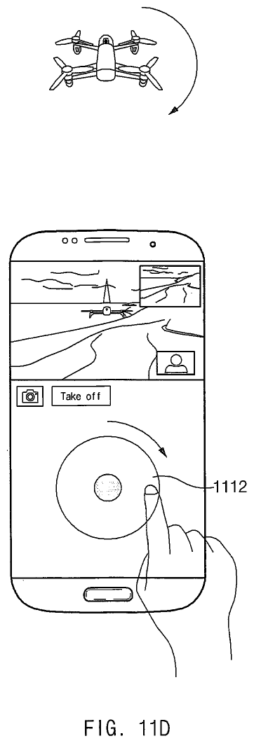

Hereinafter, an embodiment in which a UAV moves based on the first distance, the second distance, a direction facing the electronic device from the UAV, and the control information will be described with reference to FIGS. 11A to 11D.

FIG. 11A is a view illustrating that a UAV moves depending on an azimuth change of an electronic device, according to an embodiment.

Referring to FIG. 11A, in an embodiment, an electronic device 1110 may be positioned at a point P0, and a UAV 1120 may be positioned at a point P1. The one side of the electronic device 1110 may face the point P1. Afterward, the electronic device 1110 may rotate in the horizontal direction and the one side of the electronic device 1110 may face a point P2.

The sensor 110 of the electronic device 1110 may sense azimuth 1141 of the electronic device 1110 and the processor 150 of the electronic device 1110 may generate control information based on the variation of the sensed azimuth 1141. The control information generated by the processor 150 of the electronic device 1110 may include the angle between a first direction 1131 facing the point P1, which is the location of the UAV 1120, from point P0 that is the location of the electronic device 1110 and a second direction 1132 facing the target point P2, to which the UAV 200 will move, from the electronic device 1110.

The VLC output module 130 of the electronic device 1110 may output the VLC signal including the generated control information, to the UAV 1120.

The processor 250 of the UAV 1120 may determine the first distance between point P1, which is the location of the UAV 1120, and point P0 of the electronic device 1110, based on the difference value between the intensity corresponding to logic high of the VLC signal and the intensity corresponding to logic low. The second distance between the point P2, which is the target point, and the point P0 of the electronic device 1110 may be the same as the first distance. The processor 250 of the UAV 1120 may determine the direction facing the point P0, which is the location of the electronic device 1110, from the UAV 1120 based on the locations of a plurality of optical sensors and the ratio of the difference value between the intensity corresponding to logic high of the VLC signal and the intensity corresponding to logic low, which are obtained by each of the plurality of optical sensors.

The processor 250 of the UAV 1120 may determine the target point P2 based on a first distance, a second distance, a direction facing the electronic device 1110 from the UAV 1120, and the angle between the first direction 1131 and the second direction 1132. The processor 250 of the UAV 1120 may control the motor 220 such that the UAV 1120 moves to the target point P2. According to an embodiment, the processor 250 of the UAV 1120 may control the motor 220 such that the UAV 1120 moves while maintaining the distance between the UAV 1120 and the electronic device 1110.

FIG. 11B is a view illustrating that the UAV 1120 moves depending on a change of an inclination angle 1142 of the electronic device 1110, according to an embodiment.

Referring to FIG. 11B, in an embodiment, the electronic device 1110 may be positioned at the point P0, and the UAV 1120 may be positioned at the point P1. The one side of the electronic device 1110 may face the point P1. Afterward, the electronic device 1110 may rotate in the vertical direction and the one side of the electronic device 1110 may face a point P2.

The sensor 110 of the electronic device 1110 may sense the inclination angle 1142 of the electronic device 1110 and the processor 150 of the electronic device 1110 may generate control information based on the variation of the sensed inclination angle 1142. The control information generated by the processor 150 of the electronic device 1110 may include the angle between a first direction 1131 facing the point P1, which is the location of the UAV 1120, from point P0 that is the location of the electronic device 1110 and a second direction 1132 facing the target point P2, to which the UAV 1120 will move, from the electronic device 1110.

The VLC output module 130 of the electronic device 1110 may output the VLC signal including the generated control information, to the UAV 1120.

The processor 250 of the UAV 1120 may determine the first distance between point P1, which is the location of the UAV 1120, and point P0 of the electronic device 1110, based on the difference value between the intensity corresponding to logic high of the VLC signal and the intensity corresponding to logic low. The second distance between the point P2, which is the target point, and the point P0 of the electronic device 1110 may be the same as the first distance. The processor 250 of the UAV 1120 may determine the direction facing the point P1, which is the location of the electronic device 1110, from the UAV 1120 based on the locations of a plurality of optical sensors and the ratio of the difference value between the intensity corresponding to logic high of the VLC signal and the intensity corresponding to logic low of the VLC signal, which are obtained by each of the plurality of optical sensors.

The processor 250 of UAV 1120 may determine the target point P2 based on a first distance, a second distance, a direction facing the electronic device 1110 from the UAV 1120, and the angle between the first direction 1131 and the second direction 1132. The processor 250 of the UAV 1120 may control the motor 220 such that the UAV 1120 moves to the target point P2. According to an embodiment, the processor 250 of the UAV 1120 may control the motor 220 such that the UAV 1120 moves while maintaining the distance between the UAV 1120 and the electronic device 1110.

According to various embodiments, the sensor 110 of the electronic device 1110 may sense the azimuth 1141 and the inclination angle 1142 of the electronic device 1110 and the processor 150 of the electronic device 1110 may generate control information based on the variation of the sensed azimuth 1141 and the sensed inclination angle 1142. The optical sensor 211 of the UAV 1120 may obtain the VLC signal including the control information. The processor 250 of the UAV 1120 may control the motor 220 such that the UAV 1120 moves to the target point P2 determined based on the control information.

FIG. 11C is a view illustrating that the UAV 1120 moves depending on a user input to generate distance change information, according to an embodiment.

Referring to FIG. 11C, in an embodiment, the electronic device 1110 may be positioned at the point P0, and the UAV 1120 may be positioned at the point P1.

The input device 120 of the electronic device 1110 may obtain a user input to generate the distance change information between the electronic device 1110 P0 and the target point P2. For example, as illustrated in FIG. 11C, the input device 120 may obtain a user input to upwardly drag a movement control UI 1111. The processor 150 of the electronic device 1110 may generate the distance change information for increasing the distance between the electronic device 1110 P0 and the target point P2 based on the user input. The distance change information may include at least one of the variation (D2−D1), the changed speed, or the changed acceleration of the distance between the electronic device 1110 P0 and the target point P2.

In an embodiment, the variation, the changed speed, or the changed acceleration of the distance may be proportional to the extent to which the movement control UI 311 is dragged. For example, as the extent to which the movement control UI 311 is dragged is higher, the variation of the distance between the electronic device 1110 P0 and the target point P2 may be greater.

The VLC signal output by the VLC output module 130 of the electronic device 1110 may include the distance change information. The processor 250 of the UAV 1120 may determine a second distance D2 between the target point P2 and the location of the electronic device 1110 P0, by applying the distance change information to a first distance D1 between the location of the UAV 1120 and the location of the electronic device 1110.

The processor 250 of the UAV 1120 may control the motor 220 such that the UAV 1120 moves to the target point P2 determined based on the second distance, and the UAV 1120 may move to the point P2.

In an embodiment, the distance change information may include the absolute distance between the electronic device 1110 P0 and the target point P2. According to an embodiment, the input device 120 of the electronic device 1110 may obtain an input to the absolute distance between the electronic device 1110 P0 and the target point P2. The VLC output module 130 of the electronic device 1110 may output the VLC signal including the distance change information, to the UAV 1120.

According to an embodiment, the processor 250 of the UAV 1120 may determine the target point P2 such that the distance between the UAV 1120 and the electronic device 1110 is the absolute distance. The processor 250 of the UAV 1120 may control the motor 220 such that the UAV 1120 moves to the determined target point P2, and the UAV 1120 may move to the point P2. In an embodiment, the UAV 1120 may move to the target point P2, using absolute distance data of the magnitude of the VLC signal obtained through machine learning.

FIG. 11D is a view illustrating that the UAV 1120 changes a posture depending on a user input to generate posture change information, according to an embodiment.

Referring to FIG. 11D, the input device 120 of the electronic device 1110 may obtain a user input to generate the posture change information of the electronic device 1110. For example, as illustrated in FIG. 11D, the input device may obtain a user input to drag the posture change UI 1111 of the UAV 1120 clockwise. The processor 150 of the electronic device 1110 may generate posture change information that allows the UAV 1120 rotates clockwise, based on the user input. The posture change information may include the variation of an angle of a direction in which one side of the housing of the UAV 1120 faces.

The VLC signal output by the VLC output module 130 of the electronic device 1110 may include the posture change information.

The processor 250 of the UAV 1120 may control the motor 220 such that the housing clockwise rotates further based on the posture change information.

According to various embodiments, embodiments described with reference to FIGS. 11A to 11D may be implemented independently and may be also implemented complexly.

For example, while the electronic device 1110 detects the azimuth and the inclination angle, the electronic device 1110 may obtain a user input to generate the distance change information and the posture change information. The processor 150 of the electronic device 1110 may generate the control information based on the detected azimuth and the detected inclination angle and the obtained user input and may output the VLC signal including the generated control information to the UAV 1120. The UAV 1120 may change the distance to the electronic device 1110 and the posture of the UAV 1120 based on the control information included in the obtained VLC signal and may move in a diagonal direction.

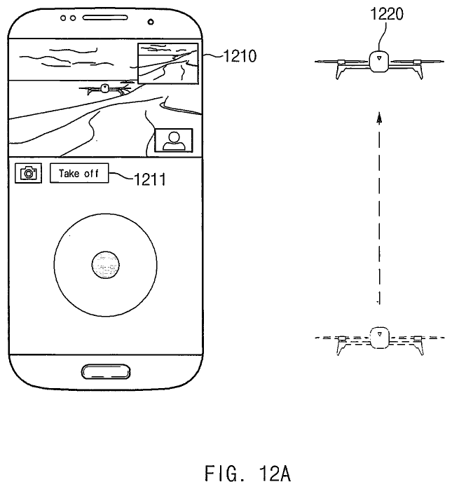

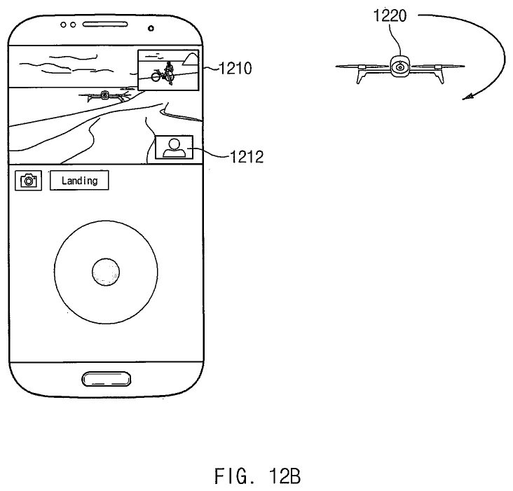

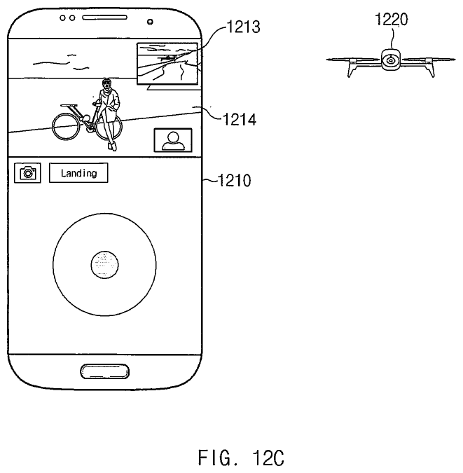

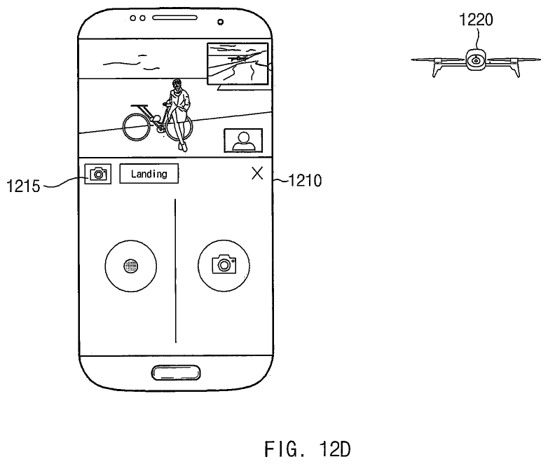

According to various embodiments, operations of an electronic device and a UAV according to a user input will be described with reference to FIGS. 12A to 12D.

UIs 1211, 1212, and 1215 displayed by the display of FIGS. 12A to 12D and viewfinders 1213 and 1214 may correspond to the UIs 317, 313, 316 displayed by the display of FIG. 3A and the viewfinders 315 and 314.

FIG. 12A is a view illustrating that a UAV takes off by a user input, according to an embodiment.

In an embodiment, an electronic device 1210 may obtain a user input to select a takeoff/landing control UI 1211 illustrated in FIG. 12A. The processor 150 of the electronic device 1210 may generate control information including a takeoff command, in response to the obtaining of the user input. The processor 150 of the electronic device 1210 may output the VLC signal including the control information to a UAV 1220 through the VLC output module 130. The UAV 1220 may take off to the predetermined height based on the control information included in the obtained VLC signal. According to an embodiment, the processor 150 of the electronic device 1210 may output a signal for making a request for pairing with the UAV 1220, to the UAV 1220 through the VLC output module 130 in response to the obtaining of the user input.

FIG. 12B is a view illustrating that the UAV 1220 rotates by a user input such that one side of the UAV 1220 faces the electronic device 1210, according to an embodiment.

In an embodiment, the electronic device 1210 may obtain a user input to select a posture change UI 1212 illustrated in FIG. 12B. The processor 150 of the electronic device 1210 may generate control information including a command to change a posture such that the camera of the UAV 1220 faces the electronic device 1210, in response to the obtaining of the user input. The processor 150 of the electronic device 1210 may output the VLC signal including the control information to the UAV 1220 through the VLC output module 130. The UAV 1220 may change the posture such that the camera faces the electronic device 1210 based on the control information included in the obtained VLC signal and the direction from the UAV 1220 to the electronic device 1210.

FIG. 12C is a view illustrating an image in which a viewfinder is displayed is switched by a user input, according to an embodiment.

In an embodiment, the electronic device 1210 may obtain a user input to select the smaller viewfinder 1213 of the two viewfinders 1213 and 1214 illustrated in FIG. 12C. The electronic device 1210 may switch images displayed by two viewfinders, in response to the obtaining of the user input. For example, the user input to select a small viewfinder 1213 may be obtained while the image captured by the camera of the electronic device 1210 is displayed on the large viewfinder 1214. In response to the user input, the electronic device 1210 may display the image captured by the camera of the UAV 1220, on the large viewfinder 1214 and may display the image captured by the camera of the electronic device 1210, on the small viewfinder 1213.

FIG. 12D is a view illustrating that a capture mode of the electronic device 1210 is executed by a user input, according to an embodiment.

In an embodiment, the electronic device 1210 may obtain a user input to select a camera control UI 1215 illustrated in FIG. 12D. The electronic device 1210 may display a UI for obtaining a still image or video of the camera of the electronic device 1210 or the camera of the UAV 1220, in response to the obtaining of the user input.

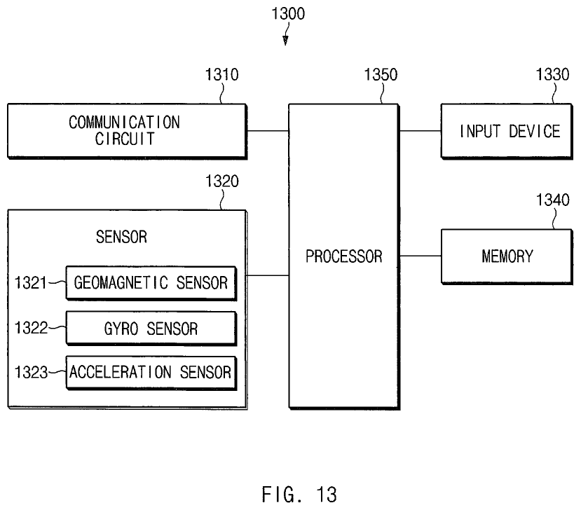

Hereinafter, a method in which an electronic device according to various embodiments controls the movement of a UAV and controls the camera of a UAV will be described with reference to FIGS. 13 to 18.

FIG. 13 is a block diagram of an electronic apparatus according to an embodiment.

According to an embodiment, an electronic device 1300 may include housing and may include a communication circuit 1310, a sensor 1320, an input device 1330, a memory 1340, and a processor 1350.

The communication circuit 1310 may include various modules to support the communication with a UAV 1400. For example, the communication circuit 1310 may include a cellular module for supporting cellular communication such as 2G/3G, LTE, LTE-Advanced (LTE-A), code division multiple access (CDMA), wideband CDMA (WCDMA), universal mobile telecommunications system (UMTS), or wireless broadband (WiBro). Furthermore, the communication circuit 1310 may include a Wi-Fi module for supporting Internet access through access point (AP) such as Wi-Fi. Moreover, the communication circuit 1310 may include a Bluetooth module for the communication with the UAV 1400. A global positioning system (GPS) module for obtaining location information may be included.

The sensor 1320 may sense the posture and the movement of the electronic device 1300 and may include at least one of a geomagnetic sensor 1321, a gyro sensor 1322, or an acceleration sensor 1323.

The input device 1330 may generate an input signal according to a user input of the electronic device 1300.

The memory 1340 may store at least one application or data associated with the operation of the electronic device 1300. According to an embodiment, the memory 1340 may store an operation application program associated with the operation of the UAV 1400. According to various embodiments, the application program may include an instruction set for transmitting, to the UAV 1400, posture change information of the UAV 1400 and control information for moving the UAV 1400.

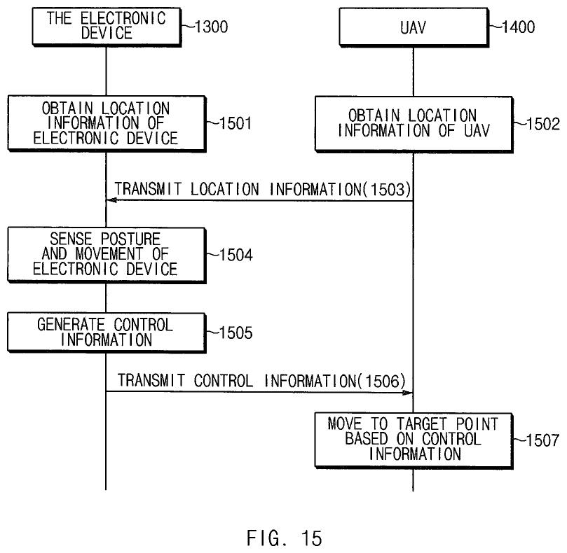

The processor 1350 may process or transmit a signal associated with the control of the electronic device 1300. According to an embodiment, the processor 1350 may be disposed in the housing and may be electrically connected to the communication circuit 1310, the sensor 1320, the input device 1330, and the memory 1340. According to an embodiment, the processor 1350 may determine a target point, to which the UAV 1400 will move, based on at least one of the detected posture and movement of the electronic device 1300, the location of the electronic device 1300, and the location of the UAV 1400. The processor 1350 may generate control information that allows the UAV 1400 to move to the target point and may transmit the control information to the UAV 1400, using the communication circuit 1310. The described operation of the processor 1350 will be described below with reference to FIGS. 15 to 17B

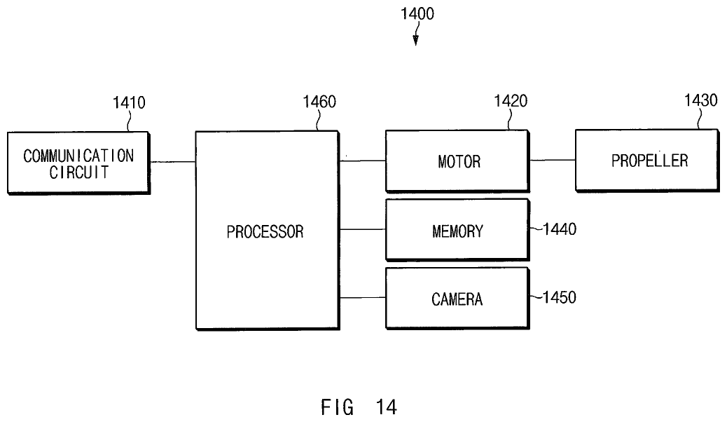

FIG. 14 illustrates a block diagram of a UAV, according to an embodiment.

According to an embodiment, the UAV 1400 may include housing and may include a communication circuit 1410, a motor 1420, a propeller 1430, a memory 1440, a camera module 1450, and a processor 1460.

The communication circuit 1410 may include various modules to support the communication with an electronic device. In particular, various modules included in the above-described electronic device may be included.

Each of the motor 1420 and the propeller 1430 is a driving means for moving the UAV 1400. One or more motors 1420 and one or more propellers 1430 may be provided. The motor 1420 may be connected to the housing and may be controlled by the processor 1460. The propeller 1430 may be connected to the motor 1420; as the motor 1420 operates, the propeller 1430 may rotate to generate lift force, and thus may move the UAV 1400.

The memory 1440 may store at least one program, at least one application, at least a piece of data, or the like associated with the operation of the UAV 1400. According to an embodiment, the memory 1440 may store a flight application associated with operation control for moving or rotating the UAV 1400, based on the control information received through the communication circuit 1410. For example, the flight application may include instruction set for extracting posture change information in the collected control information provided by the electronic device or control information for moving the UAV 1400 in response to the posture or the movement of the electronic device, an instruction set for moving the UAV 1400 depending on the extracted control information, or the like.

The camera module 1450 may be connected to the housing to obtain an image. The camera module 1450 may receive a camera driving signal from the processor 1460 to control the camera. For example, the camera module 1450 may receive a capture start signal, a pause signal, or a stop signal from the control unit to control the camera. The camera module 1450 may include a frame and a frame driving unit. The frame driving unit of the camera may control the direction change or the like of a frame in which a camera is installed. For example, the frame driving unit may receive a pitch up/down signal of a camera frame, a roll left/right signal of the camera frame, a rotation signal of the camera frame, or the like from the processor 1460 to rotate each motor, and thus, may change the direction of the frame.

The processor 1460 may process a signal associated with the control of the UAV 1400. According to an embodiment, the processor 1460 may be disposed within the housing and may be electrically connected to the communication circuit 1410, the motor 1420, the memory 1440, and camera module 1450. According to an embodiment, the processor 1460 may control the motor 1420 such that the UAV 1400 moves to the target point based on the control information. The detailed operation of the processor 1460 will be described below with reference to FIGS. 15 to 17B

FIG. 15 is a flowchart illustrating a procedure in which an electronic device controls a UAV, according to an embodiment.

The electronic device 1300 and the UAV 1400 of FIG. 15 may include all or part of components of the electronic device 1300 and the UAV 1400 described with reference to FIGS. 13 and 14.

In operation 1501, the electronic device 1300 may obtain the location information of the electronic device 1300, using a GPS module.

In operation 1502, the UAV 1400 may obtain the location information of the UAV 1400, using the GPS module.

In operation 1503, the UAV 1400 may transmit the location information of the UAV 1400 obtained using the communication circuit 1410, to the electronic device 1300.

In operation 1504, the sensor 1310 of the electronic device 1300 may sense the posture and the movement of the electronic device 1300.

In an embodiment, the posture of the electronic device 1300 may mean the direction in which one side of housing faces. The geomagnetic sensor 1321 may sense the azimuth in the direction in which one side of the housing faces. The gyro sensor 1322 may sense the inclination angle in the direction in which one side of the housing faces and the inclination angle may indicate the degree of inclination of the housing. In an embodiment, the change of the posture of the electronic device 1300 may mean the rotation of the electronic device 1300, and the rotation of the electronic device 1300 may be expressed as the variation of the azimuth and the inclination angle of the direction in which one side of the housing faces.

In an embodiment, the movement of the electronic device 1300 may include the change of the posture of the electronic device 1300.

In operation 1505, the processor of the electronic device 1300 may determine a target point, to which the UAV 1400 will move, based on at least one of the posture and movement of the electronic device 1300, the location of the electronic device 1300, and the location of the UAV 1400.

In an embodiment, the processor 1350 of the electronic device 1300 may determine the horizontal direction location of the target point based on the azimuth of a direction in which one side of the electronic device 1300 faces. The target point may be positioned in the horizontal direction of the direction in which one side of the electronic device 1300 faces. The distance between the target point and the electronic device 1300 may be the distance between the electronic device 1300 and the UAV 1400.

In an embodiment, the processor 1350 of the electronic device 1300 may determine the vertical direction location of the target point based on the inclination angle of a direction in which one side of the electronic device 1300 faces. The target point may be positioned in the vertical direction of the direction in which one side of the electronic device 1300 faces. The distance between the target point and the electronic device 1300 may be the distance between the electronic device 1300 and the UAV 1400.

In an embodiment, the processor 1350 of the electronic device 1300 may determine the target point based on the inclination angle of a direction in which one side of the electronic device 1300 faces. For example, the height of the target point may be proportional to the inclination angle of the direction in which one side of the electronic device 1300 faces.

In various embodiments, the processor 1350 of the electronic device 1300 may determine the vertical rise speed of the UAV 1400 based on the inclination angle of a direction in which one side of the electronic device 1300 faces. As the inclination angle of a direction in which one side of the electronic device 1300 faces increases, the vertical rise speed of the UAV 1400 may increase. In an embodiment, when the electronic device 1300 remains as being inclined, the UAV 1400 may continue to rise.

In an embodiment, control information may include distance change information between the electronic device 1300 and the UAV 1400.

In an embodiment, before operation 1505, the input device 1330 of the electronic device 1300 may obtain a user input to generate the distance change information between the electronic device 1300 and the UAV 1400. For example, the user input to generate the distance change information may be a user input to drag the movement control UI 311 of FIG. 3A. According to an embodiment, when the processor 1350 of the electronic device 1300 obtains a user input to upwardly drag the movement control UI 311, the processor 1350 of the electronic device 1300 may generate the distance change information for increasing the distance between the electronic device 1300 and the UAV 1400.

According to an embodiment, when the processor 1350 of the electronic device 1300 obtains a user input to downwardly drag the movement control UI 311, the processor 1350 of the electronic device 1300 may generate the distance change information for decreasing the distance between the electronic device 1300 and the UAV 1400.

According to an embodiment, the distance change information may include the displacement of the distance between the electronic device 1300 and the point of the UAV 1400, the distance change speed between the electronic device 1300 and the UAV 1400, or the distance change acceleration between the electronic device 1300 and the UAV 1400.

According to an embodiment, the displacement, the distance change speed, and the distance change acceleration may be proportional to the extent to which the movement control UI 311 is dragged.

According to various embodiments, the above-described target point determining method, the method of determining the vertical rise speed of the UAV 1400 and the method of generating the distance change information between the electronic device 1300 and the UAV 1400 may be combined and used.

In an embodiment, when a user input to trigger the generation of control information is obtained, the processor 1350 of the electronic device 1300 may generate the control information.

According to an embodiment, the user input to trigger the generation of the control information may be a user input to select the movement control UI 311 illustrated in FIG. 3A.

According to an embodiment, the user input to trigger the generation of the control information may be a user input to press the movement control button 341 of the UAV 1400 illustrated in FIG. 3B.

According to an embodiment, the user input to trigger the generation of the control information may be a user input in which a user input to select the movement control UI 311 illustrated in FIG. 3A or a user input to press the movement control button 341 of the UAV 1400 illustrated in FIG. 3B is held during a specific time period.

For example, the processor 1350 of the electronic device 1300 may determine the target point, using at least one of the posture and movement of the electronic device 1300 while a user input to trigger the generation of the control information is obtained.

According to various embodiments, a method of controlling the above-described UAV 1400 depending on a type of the obtained input may be determined. For example, when a user input to select the movement control UI 311 is obtained, the processor 1350 of the electronic device 1300 may determine the vertical rise speed of the UAV 1400 based on the inclination angle of a direction in which one side of the electronic device 1300 faces. For example, when an input in which a user input to select the movement control UI 311 is held is obtained, the processor 1350 of the electronic device 1300 may determine the vertical direction location of the target point based on the inclination angle of a direction in which one side of the electronic device 1300 faces.

The processor 1350 of the electronic device 1300 may generate control information that allows the UAV 1400 to move from the location of the UAV 1400 to the target point.

In an embodiment, the control information may include the posture change information for changing the posture of the UAV 1400. The posture of the UAV 1400 may mean the direction in which one side of the housing of the UAV 1400 faces.

In an embodiment, before operation 1505, the input device of the electronic device 1300 may obtain a user input to generate the posture change information of the UAV 1400.

For example, the user input to generate the posture change information may be a user input to drag the posture change UI 312 along the circle of the posture change UI 312 of the UAV of FIG. 3A. According to an embodiment, when the processor 1350 of the electronic device 1300 obtains a user input to drag the posture change UI 312 of the UAV clockwise, the processor 1350 of the electronic device 1300 may generate the posture change information that allows the UAV 1400 to rotate clockwise.

The control information may include at least one of roll information, pitch information, or yaw information associated with the movement of the UAV 1400.

In operation 1506, the processor 1350 of the electronic device 1300 may transmit the generated control information to the UAV 1400, using a communication circuit.

In operation 1507, the processor 1460 of the UAV 1400 may control the motor such that the UAV 1400 moves to the target point based on the control information.

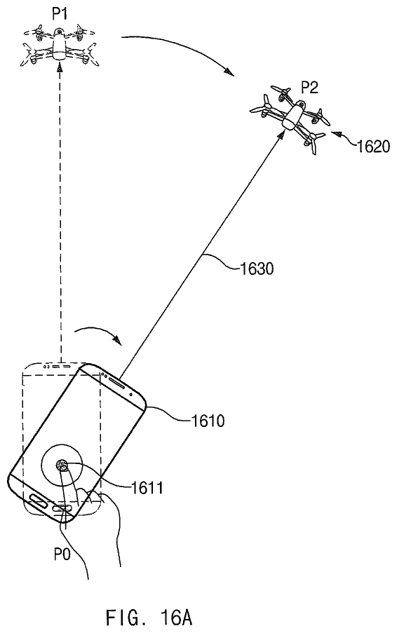

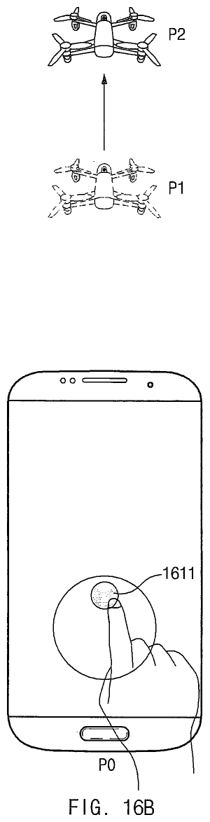

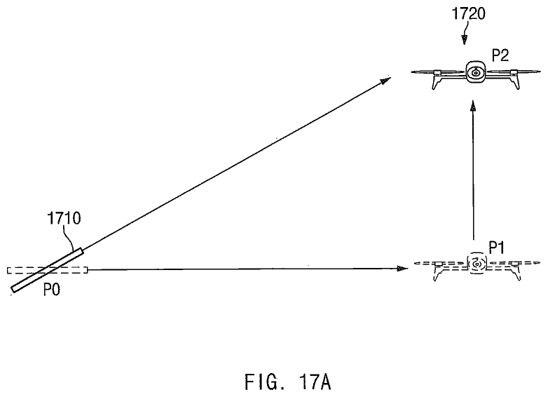

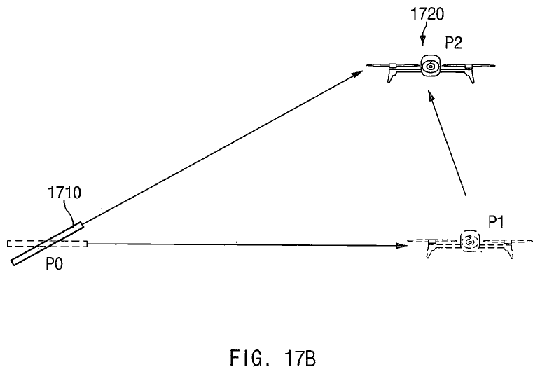

Hereinafter, an embodiment in which a UAV moves under the control of the electronic device will be described with reference to FIGS. 16A to 17B.

FIG. 16A is a view illustrating that a UAV moves depending on rotation of an electronic device, according to an embodiment.

Referring to FIG. 16A, in an embodiment, an electronic device 1610 may be positioned at a point P0, and a UAV 1620 may be positioned at a point P1. The one side of the electronic device 1610 may face the point P1.

The electronic device 1610 may obtain the location information P0 of the electronic device 1610 and the location information P1 of the UAV 1620.

Afterward, the electronic device 1610 may obtain a user input to trigger the generation of control information and may rotate in the horizontal direction and thus one side of the electronic device 1610 may face the point P2.

The processor 1350 of the electronic device 1610 may determine the horizontal direction location of the target point P2 based on location information P0 of the electronic device 1610, location information P1 of the UAV 1620, and the azimuth of a direction in which the one side of the electronic device 1610 faces. The processor 1350 of the electronic device 1610 may generate control information that allows the UAV 1620 to move from the point P1 to the point P2. At this time, the distance from the point P0 to the point P2 may be the same as the distance from the point P0 to the point P1.

The processor 1460 of the UAV 1620 may control the motor such that the UAV 1620 moves to the target point P2 based on the control information.

FIG. 16B is a view illustrating that the UAV 1620 moves depending on a distance change input, according to an embodiment.

Referring to FIG. 16B, in an embodiment, the UAV 1620 may be positioned at the point P1.

The input device of the electronic device 1610 may obtain a user input to generate the distance change information between the electronic device 1610 and the UAV 1620. For example, as illustrated in FIG. 16B, the input device may obtain a user input to upwardly drag a movement control UI 1611. The processor 1350 of the electronic device 1610 may generate the distance change information for increasing the distance between the electronic device 1610 and the UAV 1620 based on the user input.

The UAV 1620 may receive distance change information from the electronic device 1610 and may move in a direction in which the UAV 1620 is further away from the electronic device 1610 based on the received distance change information.

FIG. 17A is a view illustrating that an altitude of a UAV is changed depending on the inclination of an electronic device, according to an embodiment.

Referring to FIG. 17A, in an embodiment, a UAV may be positioned at the point P1.

The inclination angle of a direction in which one side of an electronic device 1710 faces may have a specific positive value. The processor 1350 of the electronic device 1710 may determine the vertical rise speed of the UAV based on the inclination angle of a direction in which one side of the electronic device 1710 faces.

The UAV may receive rise speed information from the electronic device 1710 and may rise at the received rise speed.

FIG. 17B is a view illustrating that an altitude of a UAV is changed depending on the inclination of the electronic device 1710, according to another embodiment.

Referring to FIG. 17B, in an embodiment, the electronic device 1710 may be positioned at the point P0, and a UAV may be positioned at the point P1. The one side of the electronic device 1710 may face the point P1.

The electronic device 1710 may obtain the location information P0 of the electronic device 1710 and the location information P1 of the UAV.

Afterward, the electronic device 1710 may rotate in the horizontal direction and the one side of the electronic device 1710 may face a point P2.

The processor 1350 of the electronic device 1710 may determine the vertical direction location of the target point P2 based on location information P0 of the electronic device 1710, location information P1 of the UAV, and the inclination angle of a direction in which the one side of the electronic device 1710 faces. The processor 1350 of the electronic device 1710 may generate control information that allows the UAV to move from the point P1 to the point P2: At this time, the distance from the point P0 to the point P2 may be the same as the distance from the point P0 to the point P1.

The processor 1460 of the UAV may control the motor such that the UAV moves to the target point P2 based on the control information.

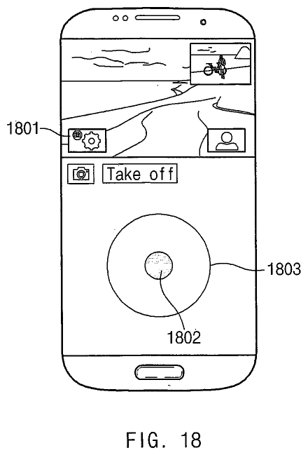

FIG. 18 illustrates a screen in which a UI for controlling movement of a camera of a UAV is displayed, according to an embodiment.

In an embodiment, referring to FIG. 18, the display of an electronic device may display a movement control activation UI 1801 of a camera, a direction change UI 1802 of the camera, and a rotation UI 1803 of the camera.

In an embodiment, when obtaining a user input to select the movement control activation UI 1801 of the camera, the electronic device may execute a mode of controlling the movement of the camera of the UAV 1400.

In an embodiment, when the mode of controlling the movement of the camera is executed, the processor of the electronic device may generate camera movement control information.

In an embodiment, the processor of the electronic device may generate the camera movement control information based on a user input to drag the direction change UI 1802 of the camera. For example, when the direction change UI 1802 of the camera is dragged vertically, the processor of the electronic device may generate pitch up/down control information of the camera of the UAV 1400. When the direction change UI 1802 of the camera is dragged horizontally, the processor of the electronic device may generate roll left/right control information of the camera of the UAV 1400.

In an embodiment, the processor of the electronic device may generate the camera rotation control information based on a user input to drag the rotation UI 1803 of the camera. For example, when the processor of the electronic device obtains a user input to drag the rotation UI 1803 of the camera clockwise, the processor of the electronic device may generate camera rotation control information that allows the camera of the UAV 1400 to rotate clockwise.

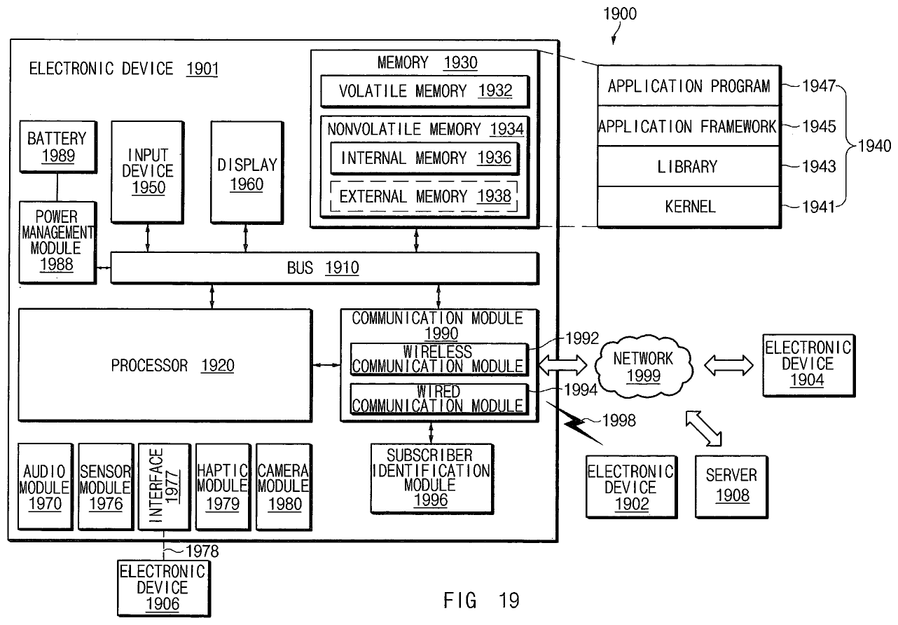

FIG. 19 is a block diagram of an electronic device in a network environment, according to various embodiments. An electronic device according to various embodiments of the disclosure may include various forms of devices. For example, the electronic device may include at least one of, for example, portable communication devices (e.g., smartphones), computer devices (e.g., personal digital assistants (PDAs), tablet personal computers (PCs), laptop PCs, desktop PCs, workstations, or servers), portable multimedia devices (e.g., electronic book readers or Motion Picture Experts Group (MPEG-1 or MPEG-2) Audio Layer 3 (MP3) players), portable medical devices (e.g., heartbeat measuring devices, blood glucose monitoring devices, blood pressure measuring devices, and body temperature measuring devices), cameras, or wearable devices. The wearable device may include at least one of an accessory type (e.g., watches, rings, bracelets, anklets, necklaces, glasses, contact lens, or head-mounted-devices (HMDs)), a fabric or garment-integrated type (e.g., an electronic apparel), a body-attached type (e.g., a skin pad or tattoos), or a bio-implantable type (e.g., an implantable circuit). According to various embodiments, the electronic device may include at least one of, for example, televisions (TVs), digital versatile disc (DVD) players, audios, audio accessory devices (e.g., speakers, headphones, or headsets), refrigerators, air conditioners, cleaners, ovens, microwave ovens, washing machines, air cleaners, set-top boxes, home automation control panels, security control panels, game consoles, electronic dictionaries, electronic keys, camcorders, or electronic picture frames.

In another embodiment, the electronic device may include at least one of navigation devices, satellite navigation system (e.g., Global Navigation Satellite System (GNSS)), event data recorders (EDRs) (e.g., black box for a car, a ship, or a plane), vehicle infotainment devices (e.g., head-up display for vehicle), industrial or home robots, drones, automated teller machines (ATMs), points of sales (POSs), measuring instruments (e.g., water meters, electricity meters, or gas meters), or internet of things (e.g., light bulbs, sprinkler devices, fire alarms, thermostats, or street lamps). The electronic device according to an embodiment of the disclosure may not be limited to the above-described devices, and may provide functions of a plurality of devices like smartphones which have measurement function of personal biometric information (e.g., heart rate or blood glucose). In the disclosure, the term “user” may refer to a person who uses an electronic device or may refer to a device (e.g., an artificial intelligence electronic device) that uses the electronic device.

Referring to FIG. 19, under the network environment 1900, the electronic device 1901 (e.g., the electronic device 100) may communicate with an electronic device 1902 through local wireless communication 1998 or may communicate with an electronic device 1904 or a server 1908 through a network 1999. According to an embodiment, the electronic device 1901 may communicate with the electronic device 1904 through the server 1908.

According to an embodiment, the electronic device 1901 may include a bus 1910, a processor 1920 (e.g., the processor 150), a memory 1930, an input device 1950 (e.g., a micro-phone or a mouse), a display device 1960, an audio module 1970, a sensor module 1976, an interface 1977, a haptic module 1979, a camera module 1980, a power management module 1988, a battery 1989, a communication module 1990, and a subscriber identification module 1996. According to an embodiment, the electronic device 1901 may not include at least one (e.g., the display device 1960 or the camera module 1980) of the above-described components or may further include other component(s).

The bus 1910 may interconnect the above-described components 1920 to 1990 and may include a circuit for conveying signals (e.g., a control message or data) between the above-described components.

The processor 1920 may include one or more of a central processing unit (CPU), an application processor (AP), a graphic processing unit (GPU), an image signal processor (ISP) of a camera or a communication processor (CP). According to an embodiment, the processor 1920 may be implemented with a system on chip (SoC) or a system in package (SiP). For example, the processor 1920 may drive an operating system (OS) or an application program to control at least one of another component (e.g., hardware or software component) of the electronic device 1901 connected to the processor 1920 and may process and compute various data. The processor 1920 may load a command or data, which is received from at least one of other components (e.g., the communication module 1990), into a volatile memory 1932 to process the command or data and may store the result data into a nonvolatile memory 1934.

The memory 1930 may include, for example, the volatile memory 1932 or the nonvolatile memory 1934. The volatile memory 1932 may include, for example, a random access memory (RAM) (e.g., a dynamic RAM (DRAM), a static RAM (SRAM), or a synchronous DRAM (SDRAM)). The nonvolatile memory 1934 may include, for example, a programmable read-only memory (PROM), an one time PROM (OTPROM), an erasable PROM (EPROM), an electrically EPROM (EEPROM), a mask ROM, a flash ROM, a flash memory, a hard disk drive (HDD), or a solid-state drive (SSD). In addition, the nonvolatile memory 1934 may be configured in the form of an internal memory 1936 or the form of an external memory 1938 which is available through connection only if necessary, according to the connection with the electronic device 1901. The external memory 1938 may further include a flash drive such as compact flash (CF), secure digital (SD), micro secure digital (Micro-SD), mini secure digital (Mini-SD), extreme digital (xD), a multimedia card (MMC), or a memory stick. The external memory 1938 may be operatively or physically connected with the electronic device 1901 in a wired manner (e.g., a cable or a universal serial bus (USB)) or a wireless (e.g., Bluetooth) manner.

For example, the memory 1930 may store, for example, at least one different software component, such as a command or data associated with the program 1940, of the electronic device 1901. The program 1940 may include, for example, a kernel 1941, a library 1943, an application framework 1945 or an application program (interchangeably, “application”) 1947.

The input device 1950 may include a microphone, a mouse, or a keyboard. According to an embodiment, the keyboard may include a keyboard physically connected or a virtual keyboard displayed through the display device 1960.

The display device 1960 may include a display, a hologram device or a projector, and a control circuit to control a relevant device. The display may include, for example, a liquid crystal display (LCD), a light emitting diode (LED) display, an organic LED (OLED) display, a microelectromechanical systems (MEMS) display, or an electronic paper display. According to an embodiment, the display may be flexibly, transparently, or wearably implemented. The display may include a touch circuitry, which is able to detect a user's input such as a gesture input, a proximity input, or a hovering input or a pressure sensor (interchangeably, a force sensor) which is able to measure the intensity of the pressure by the touch. The touch circuit or the pressure sensor may be implemented integrally with the display or may be implemented with at least one sensor separately from the display. The hologram device may show a stereoscopic image in a space using interference of light. The projector may project light onto a screen to display an image. The screen may be located inside or outside the electronic device 1901.

The audio module 1970 may convert, for example, from a sound into an electrical signal or from an electrical signal into the sound. According to an embodiment, the audio module 1970 may acquire sound through the input device 1950 (e.g., a microphone) or may output sound through an output device (not illustrated) (e.g., a speaker or a receiver) included in the electronic device 1901, an external electronic device (e.g., the electronic device 1902 (e.g., a wireless speaker or a wireless headphone)) or an electronic device 1906 (e.g., a wired speaker or a wired headphone) connected with the electronic device 1901.

The sensor module 1976 may measure or detect, for example, an internal operating state (e.g., power or temperature) of the electronic device 1901 or an external environment state (e.g., an altitude, a humidity, or brightness) to generate an electrical signal or a data value corresponding to the information of the measured state or the detected state. The sensor module 1976 may include, for example, at least one of a gesture sensor, a gyro sensor, a barometric pressure sensor, a magnetic sensor, an acceleration sensor, a grip sensor, a proximity sensor, a color sensor (e.g., a red, green, blue (RGB) sensor), an infrared sensor, a biometric sensor (e.g., an iris sensor, a fingerprint senor, a heartbeat rate monitoring (HRM) sensor, an e-nose sensor, an electromyography (EMG) sensor, an electroencephalogram (EEG) sensor, an electrocardiogram (ECG) sensor), a temperature sensor, a humidity sensor, an illuminance sensor, or an UV sensor. The sensor module 1976 may further include a control circuit for controlling at least one or more sensors included therein. According to an embodiment, the electronic device 1901 may control the sensor module 1976 by using the processor 1920 or a processor (e.g., a sensor hub) separate from the processor 1920. In the case that the separate processor (e.g., a sensor hub) is used, while the processor 1920 is in a sleep state, the separate processor may operate without awakening the processor 1920 to control at least a portion of the operation or the state of the sensor module 1976.

According to an embodiment, the interface 1977 may include a high definition multimedia interface (HDMI), a universal serial bus (USB), an optical interface, a recommended standard 232 (RS-232), a D-subminiature (D-sub), a mobile high-definition link (MHL) interface, a SD card/MMC (multi-media card) interface, or an audio interface. A connector 1978 may physically connect the electronic device 1901 and the electronic device 1906. According to an embodiment, the connector 1978 may include, for example, an USB connector, an SD card/MMC connector, or an audio connector (e.g., a headphone connector).

The haptic module 1979 may convert an electrical signal into mechanical stimulation (e.g., vibration or motion) or into electrical stimulation. For example, the haptic module 1979 may apply tactile or kinesthetic stimulation to a user. The haptic module 1979 may include, for example, a motor, a piezoelectric element, or an electric stimulator.

The camera module 1980 may capture, for example, a still image and a moving picture. According to an embodiment, the camera module 1980 may include at least one lens (e.g., a wide-angle lens and a telephoto lens, or a front lens and a rear lens), an image sensor, an image signal processor, or a flash (e.g., a light emitting diode or a xenon lamp).

The power management module 1988, which is to manage the power of the electronic device 1901, may constitute at least a portion of a power management integrated circuit (PMIC).

The battery 1989 may include a primary cell, a secondary cell, or a fuel cell and may be recharged by an external power source to supply power at least one component of the electronic device 1901.

The communication module 1990 may establish a communication channel between the electronic device 1901 and an external device (e.g., the first external electronic device 1902, the second external electronic device 1904, or the server 1908). The communication module 1990 may support wired communication or wireless communication through the established communication channel. According to an embodiment, the communication module 1990 may include a wireless communication module 1992 or a wired communication module 1994. The communication module 1990 may communicate with the external device through a first network 1998 (e.g. a wireless local area network such as Bluetooth or infrared data association (IrDA)) or a second network 1999 (e.g., a wireless wide area network such as a cellular network) through a relevant module among the wireless communication module 1992 or the wired communication module 1994.

The wireless communication module 1992 may support, for example, cellular communication, local wireless communication, global navigation satellite system (GNSS) communication. The cellular communication may include, for example, long-term evolution (LTE), LTE Advance (LTE-A), code division multiple access (CDMA), wideband CDMA (WCDMA), universal mobile telecommunications system (UMTS), Wireless Broadband (WiBro), or Global System for Mobile Communications (GSM). The local wireless communication may include wireless fidelity (Wi-Fi), Wi-Fi Direct, light fidelity (Li-Fi), Bluetooth, Bluetooth low energy (BLE), ZigBee, near field communication (NFC), magnetic secure transmission (MST), radio frequency (RF), or a body area network (BAN). The GNSS may include at least one of a Global Positioning System (GPS), a Global Navigation Satellite System (Glonass), Beidou Navigation Satellite System (Beidou), the European global satellite-based navigation system (Galileo), or the like. In the disclosure, “GPS” and “GNSS” may be interchangeably used.

According to an embodiment, when the wireless communication module 1992 supports cellar communication, the wireless communication module 1992 may, for example, identify or authenticate the electronic device 1901 within a communication network using the subscriber identification module (e.g., a SIM card) 1996. According to an embodiment, the wireless communication module 1992 may include a communication processor (CP) separate from the processor 1920 (e.g., an application processor (AP)). In this case, the communication processor may perform at least a portion of functions associated with at least one of components 1910 to 1996 of the electronic device 1901 in substitute for the processor 1920 when the processor 1920 is in an inactive (sleep) state, and together with the processor 1920 when the processor 1920 is in an active state. According to an embodiment, the wireless communication module 1992 may include a plurality of communication modules, each supporting only a relevant communication scheme among cellular communication, local wireless communication, or a GNSS communication.

The wired communication module 1994 may include, for example, a local area network (LAN) service, a power line communication, or a plain old telephone service (POTS).

For example, the first network 1998 may employ, for example, Wi-Fi direct or Bluetooth for transmitting or receiving commands or data through wireless direct connection between the electronic device 1901 and the first external electronic device 1902. The second network 1999 may include a telecommunication network (e.g., a computer network such as a LAN or a WAN, the Internet or a telephone network) for transmitting or receiving commands or data between the electronic device 1901 and the second electronic device 1904.

According to various embodiments, the commands or the data may be transmitted or received between the electronic device 1901 and the second external electronic device 1904 through the server 1908 connected with the second network 1999. Each of the first and second external electronic devices 1902 and 1904 may be a device of which the type is different from or the same as that of the electronic device 1901. According to various embodiments, all or a part of operations that the electronic device 1901 will perform may be executed by another or a plurality of electronic devices (e.g., the electronic devices 1902 and 1904 or the server 1908). According to an embodiment, in the case that the electronic device 1901 executes any function or service automatically or in response to a request, the electronic device 1901 may not perform the function or the service internally, but may alternatively or additionally transmit requests for at least a part of a function associated with the electronic device 1901 to any other device (e.g., the electronic device 1902 or 1904 or the server 1908). The other electronic device (e.g., the electronic device 1902 or 1904 or the server 1908) may execute the requested function or additional function and may transmit the execution result to the electronic device 1901. The electronic device 1901 may provide the requested function or service using the received result or may additionally process the received result to provide the requested function or service. To this end, for example, cloud computing, distributed computing, or client-server computing may be used.

Various embodiments of the disclosure and terms used herein are not intended to limit the technologies described in the disclosure to specific embodiments, and it should be understood that the embodiments and the terms include modification, equivalent, and/or alternative on the corresponding embodiments described herein. With regard to description of drawings, similar components may be marked by similar reference numerals. The terms of a singular form may include plural forms unless otherwise specified. In the disclosure disclosed herein, the expressions “A or B”, “at least one of A and/or B”, “A, B, or C”, or “at least one of A, B, and/or C”, and the like used herein may include any and all combinations of one or more of the associated listed items. Expressions such as “first,” or “second,” and the like, may express their components regardless of their priority or importance and may be used to distinguish one component from another component but is not limited to these components. When an (e.g., first) component is referred to as being “(operatively or communicatively) coupled with/to” or “connected to” another (e.g., second) component, it may be directly coupled with/to or connected to the other component or an intervening component (e.g., a third component) may be present.

According to the situation, the expression “adapted to or configured to” used herein may be interchangeably used as, for example, the expression “suitable for”, “having the capacity to”, “changed to”, “made to”, “capable of” or “designed to” in hardware or software. The expression “a device configured to” may mean that the device is “capable of” operating together with another device or other parts. For example, a “processor configured to (or set to) perform A, B, and C” may mean a dedicated processor (e.g., an embedded processor) for performing corresponding operations or a generic-purpose processor (e.g., a central processing unit (CPU) or an application processor (AP)) which performs corresponding operations by executing one or more software programs which are stored in a memory device (e.g., the memory 1930).

The term “module” used herein may include a unit, which is implemented with hardware, software, or firmware, and may be interchangeably used with the terms “logic”, “logical block”, “part”, “circuit”, or the like. The “module” may be a minimum unit of an integrated part or a part thereof or may be a minimum unit for performing one or more functions or a part thereof. The “module” may be implemented mechanically or electronically and may include, for example, an application-specific IC (ASIC) chip, a field-programmable gate array (FPGA), and a programmable-logic device for performing some operations, which are known or will be developed.

At least a part of an apparatus (e.g., modules or functions thereof) or a method (e.g., operations) according to various embodiments may be, for example, implemented by instructions stored in a computer-readable storage media (e.g., the memory 1930) in the form of a program module. The instruction, when executed by a processor (e.g., the processor 1920), may cause the processor to perform a function corresponding to the instruction. The computer-readable recording medium may include a hard disk, a floppy disk, a magnetic media (e.g., a magnetic tape), an optical media (e.g., a compact disc read only memory (CD-ROM) and a digital versatile disc (DVD), a magneto-optical media (e.g., a floptical disk)), an embedded memory, and the like. The one or more instructions may contain a code made by a compiler or a code executable by an interpreter.

Each component (e.g., a module or a program module) according to various embodiments may be composed of single entity or a plurality of entities, a part of the above-described sub-components may be omitted, or other sub-components may be further included. Alternatively or additionally, after being integrated in one entity, some components (e.g., a module or a program module) may identically or similarly perform the function executed by each corresponding component before integration. According to various embodiments, operations executed by modules, program modules, or other components may be executed by a successive method, a parallel method, a repeated method, or a heuristic method, or at least one part of operations may be executed in different sequences or omitted. Alternatively, other operations may be added.

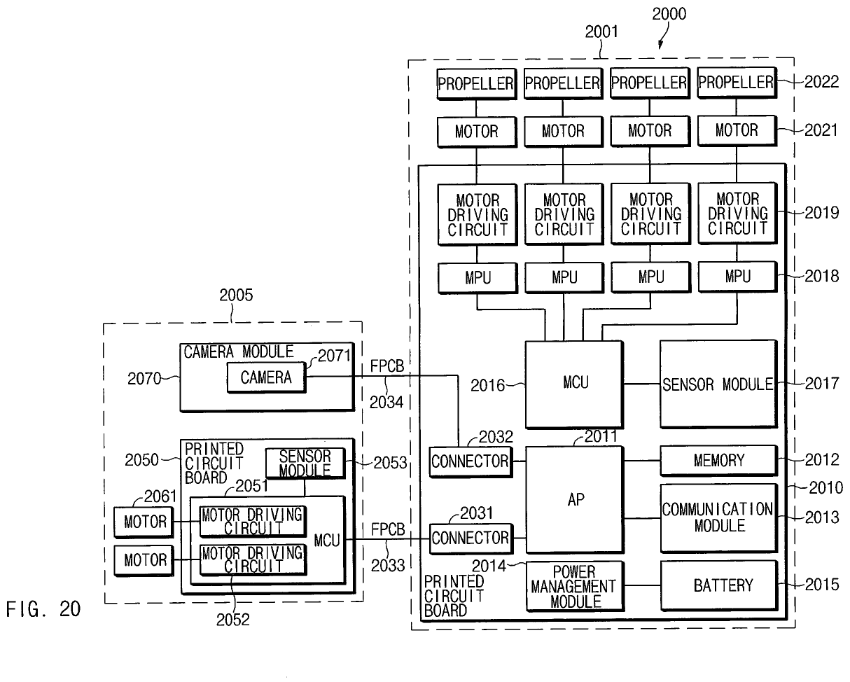

FIG. 20 is a block diagram of a UAV, according to an embodiment.

Referring to FIG. 20, a UAV 2000 may include a flight body 2001 and an imaging device 2005 that is mounted in the flight body 2001 and captures an image. The flight body 2001 may include a flight driving unit for the flight of the UAV 2000, a control unit for controlling the UAV 2000, a communication unit for communicating with a remote controller (e.g., the electronic device), and a power management module 2014 for managing the power of the UAV 2000.

The flight driving unit may generate power that floats the flight body 2001 in the air. According to an embodiment, the flight driving unit may include at least one propeller 2022, a motor 2021 for rotating the propeller 2022, a motor driving circuit 2019 for driving the motor 2021, and a motor control unit (e.g., a micro processing unit (MPU) 2018) for applying a control signal to the motor driving circuit 2019.

The control unit may drive the flight driving unit depending on the control signal received from the remote controller through the communication unit to control the movement of the UAV 2000. For example, the control unit may perform data processing or an operation associated with control and/or communication of at least one other component(s) of the UAV 2000. The control unit may be connected to the communication unit (e.g., a communication module 2013), a memory 2012, and a motor control unit so as to control each of components. The control unit may include at least one processor (e.g., an application processor (AP) 2011). According to an embodiment, the control unit may include a processor (e.g., a MCU 2016), which is connected to a sensor module 2017 and collectively manages the motor control unit.

The communication unit (e.g., the communication module 2013) (or the communication circuit) may receive the control signal of the remote controller for the control of the UAV 2000. Furthermore, the communication unit may transmit information about the flight state of the UAV 2000 to the remote controller.

The power management module 2014 may manage the power of the UAV 2000. According to an embodiment, the power management module 2014 may include a power management integrated circuit (PMIC), a charger IC, or a battery (or fuel) gauge. The PMIC may have a wired charging method and/or a wireless charging method. The wireless charging method may include, for example, a magnetic resonance method, a magnetic induction method or an electromagnetic method and may further include an additional circuit, for example, a coil loop, a resonant circuit, or a rectifier, and the like. The battery gauge may measure, for example, a remaining capacity of a battery 2015 and a voltage, current or temperature thereof while the battery is charged. The battery 2015 may include, for example, a rechargeable battery or a solar battery.

The imaging device 2005 may be mounted in the flight body 2001. The imaging device 2005 may photograph a still image and a video. The imaging device 2005 may include a camera module 2070 controlling at least one camera 2071, and a frame driving unit for controlling direction change or the like of the imaging device 2005.

The camera module 2070 may receive a camera driving signal from the control unit included in the flight body 2001 to control the camera 2071. For example, the camera module 2070 may receive a capture start signal, a pause signal, or a stop signal from the control unit to control the camera 2071. According to an embodiment, the camera module 2070 may be connected to a first connector 2032 provided in a first printed circuit board 2010, through a first flexible printed circuit board (FPCB) 2034 and may receive a camera driving signal from the AP 2011 connected to the first connector 2032.

The frame driving unit may control the direction change or the like of a frame in which a camera is installed. The frame driving unit may include at least one motor 2061 for rotating the frame, a motor driving circuit 2052 for driving the motor 2061, and a motor control unit (e.g., a MPU 2051) for applying a control signal to the motor driving circuit 2052. For example, the frame driving unit may receive a pitch up/down signal of a camera frame, a roll left/right signal of the camera frame, or the like from the control unit to rotate the motor 2061, and thus, may change the direction of the frame. According to an embodiment, a part of the frame driving unit may be mounted on a second printed circuit board 2050. Moreover, the motor control unit mounted on the second printed circuit board 2050 may be connected to a second connector 2031 provided in the first printed circuit board 2010, through a second FPCB 2033 and may receive a camera driving signal from the AP 2011 connected to the second connector 2031. In an embodiment, the frame driving unit may further include a sensor module 2053.

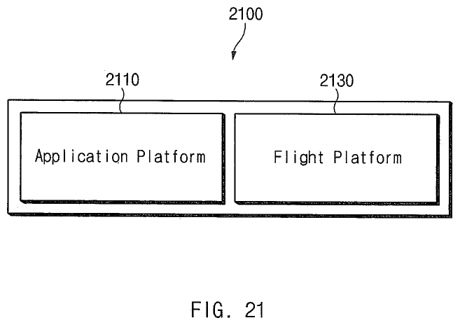

FIG. 21 is a diagram illustrating a platform of a UAV, according to an embodiment.

Referring to FIG. 21, a UAV 2100 may include an application platform 2110 and a flight platform 2130. The application platform 2110 may operate in conjunction with an electronic device (e.g., a remote controller) for controlling the UAV 2100. For example, the application platform 2110 may operate in conjunction with the remote controller through a communication channel such as LTE, or the like. In addition, the application platform 2110 may process a service such as the control of a camera installed in the UAV 2100, or the like. In an embodiment, the application platform 2110 itself may generate a control signal of the UAV 2100 through analysis of data of the camera and a sensor, or the like. The application platform 2110 may change a function capable of being supported depending on a user application, or the like. The flight platform 2130 may control the flight of the UAV 2100 depending on a navigation algorithm.

1. An electronic device comprising:
a housing;
a sensor configured to sense a movement of the electronic device;
a visible light communication (VLC) output module disposed on one side of the housing and configured to output a VLC signal; and
a processor disposed within the housing and electrically connected to the sensor and the VLC output module,
wherein the processor is configured to:
generate control information for controlling a movement of an unmanned aerial vehicle (UAV) based on the sensed movement of the electronic device; and
output the VLC signal including the control information to the UAV by using the VLC output module.

2. The electronic device of claim 1, wherein the sensor includes at least one of a geomagnetic sensor configured to sense an azimuth of the electronic device, a gyro sensor configured to sense an inclination of the electronic device, or an acceleration sensor configured to sense an acceleration of the electronic device.

3. The electronic device of claim 1, wherein the processor is configured to:
generate the control information based on the movement of the electronic device sensed from a point in time when a user input is obtained.

4. The electronic device of claim 1, wherein the control information includes an angle between a first direction from the electronic device to the UAV and a second direction from the electronic device to a target point to which the UAV will move, and
wherein the angle between the first direction and the second direction is proportional to a variation of an azimuth and an inclination angle of the electronic device.

5. The electronic device of claim 1, wherein the processor is configured to:
generate the control information based on a rotational angular velocity of the detected electronic device.

6. The electronic device of claim 5, wherein the control information includes a movement speed of the UAV, and
wherein the movement speed is proportional to the rotational angular velocity.

7. A UAV comprising:
a housing;
a plurality of optical sensors disposed on the housing and configured to obtain a VLC signal including control information from an electronic device;
a decoder configured to obtain the control information from the VLC signal;
at least one motor connected to the housing;
at least one propeller connected to the at least one motor;
a processor disposed within the housing and electrically connected to the plurality of optical sensors, the decoder, and the at least one motor, wherein the processor is configured to:
control the motor such that the UAV moves to a target point determined based on a first distance between the electronic device and the UAV, a second distance between the electronic device and the target point to which the UAV will move, a direction from the UAV to the electronic device, and the control information,
wherein the first distance is determined based on a magnitude of the obtained VLC signal, and
wherein the control information includes an angle between a first direction from the electronic device to the UAV and a second direction from the electronic device to the target point.

8. The UAV of claim 7, wherein the second distance between the electronic device and the target point is the same as the first distance.

9. The UAV of claim 7, wherein the control information includes change information of the second distance between the electronic device and the target point, and
wherein the second distance is determined based on the first distance and the change information.

10. The UAV of claim 9, wherein the change information includes an increment or a decrement of the second distance, and
wherein the second distance is a distance obtained by adding the increment to the first distance or a distance obtained by subtracting the decrement from the first distance.

11. The UAV of claim 7, wherein the control information includes posture change information of the housing, and
wherein the processor is configured to:
control the motor such that the housing changes a posture further based on the posture change information.

12. The UAV of claim 7, wherein the control information includes a rotational angular velocity of the electronic device, and
wherein the processor is configured to:
control the motor such that the UAV moves based on the rotational angular velocity.

13. The UAV of claim 12, wherein a movement speed of the UAV is proportional to the rotational angular velocity.

14. The UAV of claim 7, wherein the direction from the UAV to the electronic device is determined based on locations of the plurality of optical sensors and a magnitude of the VLC signal obtained by each of the plurality of optical sensors.

15. The UAV of claim 7, wherein the first distance is determined based on a difference value between a magnitude of a first VLC signal corresponding to logic high of the obtained VLC signal and a magnitude of a second VLC signal corresponding to logic low, and
wherein the first distance is inversely proportional to a root square of the difference value.
